SEQUENCE LISTING (1 sequence)

SEQ ID NO: 1 - protein, 622 aa, Homo sapiens
MAHVRGLQLPGCLALAALCSLVHSQHVFLAPQQARSLLQRVRRANTFLEEVRKGNLERECVEETCSYEEAFEALESSTATDVFWAKYTACETARTPRDKLAACLEGNCAEGLGTNYRGHVNITRSGIECQLWRSRYPHKPEINSTTHPGADLQENFCRNPDSSTTGPWCYTTDPTVRRQECSIPVCGQDQVTVAMTPRSEGSSVNLSPPLEQCVPDRGQQYQGRLAVTTHGLPCLAWASAQAKALSKHQDFNSAVQLVENFCRNPDGDEEGVWCYVAGKPGDFGYCDLNYCEEAVEEETGDGLDEDSDRAIEGRTATSEYQTFFNPRTFGSGEADCGLRPLFEKKSLEDKTERELLESYIDGRIVEGSDAEIGMSPWQVMLFRKSPQELLCGASLISDRWVLTAAHCLLYPPWDKNFTENDLLVRIGKHSRTRYERNIEKISMLEKIYIHPRYNWRENLDRDIALMKLKKPVAFSDYIHPVCLPDRETAASLLQAGYKGRVTGWGNLKETWTANVGKGQPSVLQVVNLPIVERPVCKDSTRIRITDNMFCAGYKPDEGKRGDACEGDSGGPFVMKSPFNNRWYQMGIVSWGEGCDRDGKYGFYTHVFRLKKWIQKVIDQFGE

(19) United States
(12) Patent Application Publication
(10) Pub. No.: US 2008/0020940 A1
(43) Pub. Date: Jan. 24, 2008

(54) BIOMARKERS FOR USE IN THE DIAGNOSIS AND TREATMENT OF COLORECTAL CANCER

(75) Inventors: Katrin Stedronsky, Winnipeg (CA); Douglas Barker, Winnipeg (CA); Yilan Zhang, Winnipeg (CA)

Correspondence Address: MERCHANT & GOULD PC, P.O. BOX 2903, MINNEAPOLIS, MN, 55402-0903, US

(73) Assignee: Miraculins Inc., Winnipeg (CA)

(21) Appl. No.: 11/782,368

(22) Filed: Jul. 24, 2007

Related U.S. Application Data
(60) Provisional application No. 60/820,134, filed on Jul. 24, 2006.
(60) Provisional application No. 60/866,769, filed on Nov. 21, 2006.
(60) Provisional application No. 60/940,317, filed on May 25, 2007.

(51) Int. Cl. C40B 30/04; C40B 40/04

(52) U.S. Cl. 506/9; 506/15

(57) ABSTRACT

The present invention relates to the field of the diagnosis of large intestine diseases. More particularly, embodiments of the invention provide a method for differential diagnosis of colorectal cancer from a non-malignant disease of the large intestine, and from a healthy large intestine.

### CROSS-REFERENCE TO RELATED APPLICATIONS

This application claims the benefit of priority under 35 U.S.C. §119(e) of U.S. Provisional Application No. 60/820,134, filed Jul. 24, 2006, U.S. Provisional Application No. 60/866,769, filed Nov. 21, 2006, and U.S. Provisional Application No. 60/940,317, filed May 25, 2007, the entire disclosures of which are hereby incorporated by reference.

### FIELD OF THE INVENTION

The present invention relates to the field of the diagnosis of large intestinal diseases (including colon and rectum). More particularly, embodiments of the invention provide a method for differential diagnosis of colorectal cancer from a non-malignant disease of the large intestine, and from a healthy large intestine.

### BACKGROUND

Colorectal cancer (CRC) is the number three leading type of cancer, and the second leading cancer for estimated cancer deaths in the United States (Huang et al., 2005). In 2005, it was estimated that 149,250 new cases of CRC would be diagnosed in United States, and the estimated number of deaths as a result of CRC cancer would reach 56,290; more or less equally distributed among the genders (27,750 in women and 28,540 in men) (American Cancer Society, Cancer Facts and Figures, 2005, Atlanta: American Cancer Society 2005).). Overall, the incidence and mortality rates for this particular cancer are highest among individuals over the age of 50; 91% and 94% respectively (American Cancer Society, 2005).

Studies have shown that the incidence of CRC is determined largely by environmental exposure. Urbanization and socio-economic status such as income level, education and access to and the quality of medical care appear to have an impact on CRC incidence. North America, Europe and Australia are considered to be high-risk areas of CRC, with a prevalence in countries exhibiting a Westernised lifestyle (Janout & Kollarova, 2001). Familial and hereditary factors have been observed to play primary roles in the cause of CRC. In addition, a number of other factors have been shown to be associated with an increased risk of developing CRC, such as the presence of adenomatous polyps, history/presence of inflammatory bowel disease, diet low in fibre, fruits and vegetables, and high in fat and red meat, alcohol, tobacco, cholecystectomy and irradiation; while other factors such as aspirin, NSAIDs and calcium can play a protective role (Janout & Kollarova, 2001; Sandler, 1999).

Despite the varying hereditary or non-hereditary genetic effects linked to the development of CRC, the course of the morphological development of this cancer appears to be associated with a specific sequence of events (Wong, 2006). Typically, normal mucosa develops into an adenomatous polyp, which in some cases can progress to an adenoma with low-grade dysplasia. This type of adenoma can then, in turn, progress to a high-grade dysplasia and eventually become an invasive adenocarcinoma. Based on decades of research, the molecular mechanisms underlying these changes have been elucidated. A mutation in the gene encoding the APC (Adenomatous Polyposis Coli) protein leads to the disruption of its biological activity and subsequently increases the risk of developing early adenomas with low-grade dysplasia from the normal mucosa of the colon. Subsequently, a mutation in K-ras correlates with the progression of the early adenoma to the intermediate stage characterised by a low-grade dysplasia. This sequence of events is followed by an allelic loss at 18q21, whereby the gene sequences encoding DCC (deleted in colon cancer), SMAD2 and SMAD4 are deleted. A similar allelic loss occurs at 17p13, wherein the gene encoding p53 is also deleted. A loss of both SMAD4 has been shown to promote the progression of the intermediate state adenoma to a late stage adenoma with high-grade dysplasia. Finally, it is the loss of the gene encoding p53 that results in the promotion of colon carcinogenesis in it later stages. (Wong, 2006).

Despite the present knowledge of the molecular mechanisms leading to the development of CRC, reliable detection methods, particularly for the early detection of the disease, are somewhat limited. Currently, the screening methods utilised by physicians include the faecal occult blood tests (FOBT), flexible sigmoidoscopy (FS), barium enema X-ray (BE), double-contrast barium enema (DCBE), colonoscopy, virtual colonoscopy (VC) and faecal DNA testing (Hendon & DiPalma, 2005; Huang et al., 2005). Due to its relative ease, safety and cost effectiveness, the FBOT is an effective method for CRC screening (Hendon & DiPalma, 2005). Despite its effectiveness as a screening method, a major disadvantage to this test is its low diagnostic yield compared to other methods, as well as its high false-positive rate (Galiatsatos & Foulkes, 2006). Moreover, studies have brought into question whether the utilization of FOBT test can actually reduce the CRC related mortality (Hendon & DiPalma, 2005; Moayyedi & Achkar, 2006; Mandel et al., 1993).

In contrast, FS is a screening method that has not only been shown to reduce the mortality rate related to CRC (Galiastsatos & Foulkes, 2006), but also to detect small polyps that are occult blood negative (Atkin et al., 1993). Like the FOBT, FS is also safe, inexpensive and cost-effective. What is more, this test can be performed without sedation (Huang et al., 2005). Unfortunately, FS is only able to detect 50% of adenomas and the level of patient discomfort is compromised (Hendon & DiPalma, 2005). FS screening followed by full colonoscopy improves the detection of adenomas significantly, such that 70-80% of all advanced neoplasias can be identified (Lieberman et al., 2000). Both the BE and DCBE are also cost effective and safe, but their sensitivity is low and they lack therapeutic capability (Hendon & DiPalma, 2005; Huang et al., 2005).

In conjunction with the number of available screening methods, colonoscopy is the recommended confirmatory method for any positive findings (Huang et al., 2005) previously detected. It allows for the visualization of the entire colon and the simultaneous performance of a biopsy and a polypectomy. The disadvantages to this technique are multiple and include high costs, the use of conscious sedation thereby increasing patient recovery time following the procedure, the need for highly trained personnel, and higher complication rates as compared to other screening methods (Huang et al., 2005).

In addition, imaging technologies such as VC, derived from computed tomography (CT) has become received broader acceptance as a CRC screening tool. It requires no sedation and it is an easy, less labour-intensive screening method as compared to the barium enema and conventional colonoscopy (Huang et al. 2005; Laghi, 2005; Bogoni et al., 2005). Currently, the disadvantages of this screening tool involves poor sensitivity for polyp detection at less than 5 mm and a relatively high false-positive rate, which may result in an unnecessary follow-up colonoscopy (Huang et al., 2005). Moreover, its radiation dose may pose a long-term risk for screened individuals (Prokop, 2005).

Finally, faecal DNA testing is based on the understanding of the molecular events that occur during the transformation of adenomas to CRC. This particular genetic screen is a neoplasm-specific and non-invasive screening method, with no bowel preparation or dietary restrictions required. It also has the potential to detect neoplasia throughout the entire length of colon from a single collection. Its current limitations are lack of dada from screening populations and the need to confine and determine how many and which markers are necessary, as well as the necessary expenses to execute the test (about $500-$800 per test) (Huang et al., 2005).

Despite the availability of screening methods for the detection of CRC, no one method is able to detect CRC within its early stages. As a result, significant differences exist regarding the survival of patients affected by CRC according to the stages at which the disease is diagnosed (Wong, 2006). Most patients exhibit symptoms such as rectal bleeding, pain, abdominal distension or weight loss only after the disease is in its advanced stages, leaving little therapeutic options available. Diagnosis at an early stage, prior to lymph-node spread, can significantly improve the rate of survival as compared to a diagnosis established at a later stage of the disease, since the therapies used to treat colorectal cancer are stage-dependent.

Based on this, physicians and patients should discuss the advantages and disadvantages of each option when deciding which of the tests to perform. In order to reduce colorectal cancer mortality, it is suggested that people age 50 or older with no other risk factor should be screened for CRC (Huang et al., 2005; Wong, 2006). The high-risk population, including the ones that have a family or personal history of colorectal cancer, colorectal polyps, or chronic inflammatory bowel disease, should be tested prior to the age of 50 (Cancer Facts and Figures, 2005). However, the utilization of CRC screening methods remains low. Some of the major problems from the public include a fear of being hurt by the techniques used, particularly the colonoscopy, as well as an unawareness of the necessity for screening for the disease without symptoms (Hendon & DiPalma, 2005).

Provided herein is a new diagnostic tool for the detection of CRC in a patient. Our invention circumvents many of the conventional drawbacks of the current CRC diagnostic methods. It provides higher sensitivity and specificity for the detection of CRC than, for example, the FOBT. In addition, this new diagnostic tool provides a lower false-positive rate of diagnosis and therefore reduces the number of patients requiring further screening. The diagnostic method described herein is safe, effective (high sensitivity and specificity) and non-invasive, and is an improvement over the current state of the art.

Unlike conventional diagnostic tools such as enzyme-linked immunosorbent assays (ELISAs), SELDI-MS based diagnostics can differentiate populations of detected sample components based on observed mass to change (mm/z) ratios (Rader, 2001, DeWitt, 1993, Erb, 1994). For example, several forms of transthyretin have been detected in serum derived from normal patients and those with breast, colon, and ovarian or colorectal cancer, conferring a greater level of diagnostic accuracy than when total transthyretin is used alone (Rader, 2001). In a further example, the activity of several kinases (enzymes which reversibly phosphorylate other proteins or peptides) can be monitored by the detection of mass shifts of 80 m/z units, representing the addition or loss of a phosphate group, in reporter peptides (DeWitt, 1993).

Similarly, the generation of a mass spectrum permits the application of panels of possibly unrelated markers to disease diagnosis in one test, rather than evaluation of a single marker. The use of panels of markers represents an improvement over the state of the art by providing capabilities not present in single-marker assays, including the ability to verify that the assay was conducted correctly through monitoring of internal control or reference peaks, the ability to fine-tune parameters by several small adjustments rather than a single large one to ensure that all patients in one group (typically a diagnosis of having a deleterious condition) are correctly identified, the capacity for sub-classification of diagnosis by concurrently looking for markers characteristic of different diseases or grades of disease, and providing the clinician with multiple decision points for diagnosis.

The application of marker panels as described above also provides SELDI-MS with the advantage that marker identification (for example, by the characteristic amino acid sequence of a protein or peptide) is not necessary for the development of an accurate and reliable test. It is well known that ELISA-type tests, such as those typically used for PSA testing, require antibodies raised against a particular, known antigen. In contrast, the identity of a marker is not relevant to diagnosis by SELDI-MS, only the ability to reliably and reproducibly detect that marker under the conditions established for the test. Therefore, the selection of markers that can be reliably and reproducibly detected and differentiated from one another (for example, having different m/z ratios) is essential to creating an effective and reproducible marker panel.

It would therefore be advantageous to have a new diagnostic tool for the detection of CRC in a patient that provides higher sensitivity and/or specificity for the detection of CRC than other methods, a lower false-positive rate of diagnosis, and/or a reduction in the number of patients requiring further screening. It would also be advantageous to use the capabilities of SELDI-MS to detect and identify biomarkers capable of correctly classifying samples as those originating from patients having colorectal cancer versus having a non-colorectal cancer disease.

### SUMMARY OF THE INVENTION

The present invention relates to methods for a differential diagnosis of colorectal cancer or a non-malignant disease of the large intestine by detecting one or more differentially expressed biomolecules within a test sample of a given subject, comparing results with samples from healthy subjects, subjects having a precancerous lesion of the large intestine, subjects with non-malignant disease of the large intestine, subjects with localized colorectal cancer, subjects with metastasised colorectal cancer, and/or subjects with an acute or a chronic inflammation of the large intestines, wherein a comparison allows for a differential diagnosis of a subject as healthy, having a precancerous lesion of the large intestines, having non-malignant disease of the large intestine, having a localized colorectal cancer, having a metastasised colorectal cancer, or having an acute or chronic inflammation of the large intestine.

An embodiment of the present invention provides a method for a differential diagnosis of a non-malignant disease of the large intestine and/or a precancerous lesion of the large intestines and/or a localized colorectal cancer and/or a metastasised colorectal cancer and/or subjects with an acute or a chronic inflammation of the large intestines, in vitro, comprising obtaining a test sample from a subject, contacting the test sample with a biologically active surface under specific binding conditions, allowing for biomolecules within a test sample to bind to a biologically active surface, detecting one or more bound biomolecules using mass spectrometry thereby generating a mass profile of said test sample, transforming data into a computer-readable form, and comparing said mass profile against a database containing mass profiles specific for healthy subjects or subjects having a non-malignant disease of the large intestine and or a precancerous lesion of the large intestine and/or a localized colorectal cancer and/or a metastasised colorectal cancer and/or subjects with an acute or a chronic inflammation of the large intestine.

In one embodiment the invention, a database comprises mass profiles of biological samples from healthy subjects, subjects having a non-malignant disease of the large intestine, subjects having a precancerous lesion of the large intestine, subjects having a localized colorectal cancer, subjects having a metastasised colorectal cancer or subjects having an acute or a chronic inflammation of the large intestine.

In an embodiment, a database is generated by obtaining biological samples from healthy subjects, subjects having a non-malignant disease of the large intestine, subjects having a precancerous lesion of the large intestine, subjects having a colorectal cancer, subjects having a metastasised colorectal cancer or subjects having an acute or a chronic inflammation of the large intestines, contacting said biological samples with a biologically active surface under specific binding conditions, allowing biomolecules within the biological sample to bind said biologically active surface, detecting one or more bound biomolecules using mass spectrometry thereby generating a mass profile of said biological samples, transforming data into a computer-readable form, and applying a mathematical algorithm to classify the mass profiles as specific for healthy subjects, subjects having a non-malignant disease of the large intestine, subjects having a precancerous lesion of the large intestine, subjects having a localized colorectal cancer, subjects having a metastasised colorectal cancer or subjects having an acute or a chronic inflammation of the large intestines.

An embodiment of the invention provides biomolecules selected from the group of biomolecules M1, M2, M3, M4, M5, and M6. Biomolecules are detected by contacting a test and/or biological sample with a biologically active surface comprising an adsorbent under specific binding conditions and further analysed by gas phase ion spectrometry. Preferably the adsorbent used comprises cationic quaternary ammonium groups covalently cross-linked to an otherwise inert surface.

In an alternative embodiment, a method for the differential diagnosis of a healthy subject, subject having a non-malignant disease of the large intestine, subject having a precancerous lesion of the large intestine, subject having a localized colorectal cancer, subject having a metastasised colorectal cancer or a subject with an acute or a chronic inflammation of the large intestine comprises detecting of one or more differentially expressed biomolecules within a sample. This method comprises obtaining a test sample from a subject, contacting said sample with a binding molecule specific for a differentially expressed polypeptide, detecting an interaction between the binding molecule and its specific polypeptide, wherein the detection of an interaction indicates the presence or absence of said polypeptide, thereby allowing for the differential diagnosis of a subject as being healthy, having a non-malignant disease of the large intestine, having a precancerous lesion of the large intestine, having a localized colorectal cancer, having a metastasised colorectal cancer or having an acute or a chronic inflammation of the large intestine.

Biomolecules of the present invention include biomolecules selected from the group consisting of biomolecules M1, M2, M3, M4, M5, and M6, and may include, but are not limited to, molecules comprising nucleic acids, nucleotides, polynucleotides (DNA or RNA), amino acids, polypeptides, proteins, sugars, carbohydrates, fatty acids, lipids, steroids, antibodies, and combinations thereof (e.g., glycoproteins, ribonucleotides, lipoproteins). Preferably said biomolecules are proteins, polypeptides, or fragments thereof.

Yet another embodiment of the invention provides a method for identifying biomolecules within a sample, provided that the biomolecules are proteins, polypeptides or fragments thereof, comprising chromatography and fractionation, analysis of fractions for the presence of said differentially expressed proteins and/or fragments thereof, using a biologically active surface, further analysis using mass spectrometry to obtain amino acid sequences encoding said proteins and/or fragments thereof, and searching amino acid sequences databases of known proteins to identify said differentially expressed proteins and/or fragments thereof by amino acid sequence comparison. Preferably the method of chromatography is high performance liquid chromatography (HPLC) or fast protein liquid chromatography (FPLC). Furthermore, the mass spectrometry used is selected from the group of matrix-assisted laser desorption ionisation/time-of-flight (MALDI-TOF), surface enhanced laser desorption ionisation/time-of-flight (SELDI-TOF), liquid chromatography, MS-MS, or ESI-MS.

Furthermore, an embodiment of the invention provides kits for differential diagnosis of a non-malignant disease of the large intestine and/or a localized colorectal cancer and/or a metastasised colorectal cancer and/or an acute or a chronic inflammation of the large intestine. Embodiments can also provide kits for differential diagnosis of a subject having non-malignant disease of the large intestine, a subject having a precancerous lesion of the large intestine, a subject having a localized colorectal cancer, a subject having metastasised colorectal cancer or a subject with an acute or a chronic inflammation of the large intestine. The kits can provide a sample standard comprising biomarkers of the present invention in suspension, and can also comprise instructions for uses thereof.

A test or a biological sample may be of blood, serum, plasma, urine, semen, seminal fluid, seminal plasma, pre-ejaculatory fluid (Cowper's fluid), nipple aspirate, vaginal fluid, excreta, tears, saliva, sweat, bile, biopsy, ascites, cerebrospinal fluid, lymph, or tissue extract origin. Preferably, a test and/or biological sample is urine, blood, serum, plasma and excreta samples, and are isolated from subjects of mammalian origin, preferably of human origin. Preferred test and/or biological samples include a serum sample.

A further embodiment of the invention is a method for the diagnosis of colorectal cancer in a subject comprising obtaining a biological sample from the subject, detecting the quantity, presence, or absence of one or more biomarkers comprising at least one of biomarker M1, M2, M3, M4, M5, or M6 in a sample, and classifying a subject as having or not having colorectal cancer. Preferably, more than one of such biomarker is used, for example, M1 and M4 can be used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

A further embodiment of the invention includes a method for differential diagnosis of colorectal cancer and non-malignant disease of the large intestine in a subject comprising obtaining a biological sample from a subject, detecting the quantity, presence, or absence of a biomarker comprising at least one of biomarkers M1, M2, M3, M4, M5, or M6 in the sample, and classifying the subject as having colorectal cancer, non-malignant disease of the large intestine, or being healthy, based on the quantity, presence, or absence of said one or more biomarkers in the sample. Preferably, more than one of such biomarkers is used. For example, M1 and M3 can be used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

A further embodiment of the invention includes a method for differential diagnosis of healthy, non-malignant disease of the large intestine, precancerous lesion of the large intestine, localized colorectal cancer, metastasised colorectal cancer, and acute or chronic inflammation of the large intestine the large intestine in a subject comprising obtaining a biological sample from a subject, detecting quantity, presence, or absence of one or more biomarkers comprising at least one of biomarkers M1, M2, M3, M4, M5, or M6 in the sample, and classifying the subject as having one of these diseases or disorders, or being healthy, based on the quantity, presence, or absence of said one or more biomarkers in the sample. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

A biomarker can be used to classify a subject by contacting a biological sample with a biologically active surface, allowing the biomarker(s) within the biological sample to bind to the biologically active surface, detecting the bound biomarker(s) using a detection method, wherein the detection method generates mass profiles of the biological sample, transforming the information into a computer readable form, and comparing the information with a database containing mass profiles from subjects whose classification is known, wherein the comparison allows for differential diagnosis and classification of a subject.

A database can be generated by obtaining reference biological samples from subjects having known classification, contacting a reference biological samples with a biologically active surface, allowing biomarkers within the reference biological samples to bind to the biologically active surface, detecting bound biomarkers using a detection method, wherein the detection method generates mass profiles of said reference biological samples, transforming the mass profiles into a computer readable form, and applying a mathematical algorithm to classify the mass profiles into desired classification groups.

A method can comprise the detection of quantity, presence, or absence of a biomarker(s) by mass spectroscopy.

Mass spectroscopy can be matrix-assisted laser desorption ionization/time of flight (MALDI-TOF), surface enhanced laser desorption ionisation/time of flight (SELDI-TOF), liquid chromatography, MS-MS, or ESI-MS.

A subject may be a mammal, for example, a human, and a biological sample or reference biological sample can be blood, serum, plasma, urine, semen, seminal fluid, seminal plasma, pre-ejaculate (Cowper's fluid), nipple aspirate, vaginal fluid, excreta, tears, saliva, sweat, biopsy, ascites, cerebrospinal fluid, lymph, or tissue extract sample.

A biologically active surface may comprise an adsorbent consisting of cationic quaternary ammonium groups.

Another aspect of the present invention includes a kit for diagnosis of colorectal cancer within a subject comprising a biologically active surface comprising an absorbent, binding solutions, and instructions to use the kit. An absorbent may consist of cationic quaternary ammonium groups.

Another aspect of the present invention includes a method for in vitro diagnosis of colorectal cancer in a subject comprising detecting one or more differentially expressed biomarkers in a biological sample by obtaining the biological sample from a subject, contacting said sample with one or more binding molecules specific for one or more of biomarkers comprising at least one of biomarker M1, M2, M3, M4, M5, or M6 and detecting quantity, presence, or absence of the biomarker in the sample, wherein the quantity, presence or absence of the biomarker allows for the diagnosis of the subject as healthy or having colorectal cancer. Preferably, more than one of such biomarkers is used. In an embodiment, M1 and M4 can be used. In an embodiment, M1 and MS can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and MS can be used. In an embodiment, M2 and M6 can be used. In an embodiment, M4 and M6 can be used In an embodiment, M1, M2, M3, M4, MS and M6 can be used.

Another aspect of the present invention includes a method for in vitro diagnosis of colorectal cancer and non-malignant disease of the large intestine in a subject comprising detecting one or more differentially expressed biomarkers in a biological sample by obtaining the biological sample from the subject, contacting said sample with one or more binding molecules specific for one or more of biomarkers comprising at least one of biomarker M1, M2, M3, M4, M5, or M6, and detecting quantity, presence, or absence of the biomarker in the sample, wherein the quantity, presence or absence of the biomarker allows for the diagnosis of the subject as healthy, as having colorectal cancer, or as having non-malignant disease of the large intestine. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and MS can be used. In an embodiment, M2 and M6 can be used. In an embodiment, M1, M2, M3, M4, M5 and M6 can be used.

Another aspect of the present invention includes a method for in vitro diagnosis of colorectal cancer, non-malignant disease of the large intestine, precancerous lesion of the large intestine, localized colorectal cancer, metastasised colorectal cancer, and acute or chronic inflammation of the large intestine the large intestine in a subject comprising detecting one or more differentially expressed biomarkers in a biological sample by obtaining the biological sample from the subject, contacting said sample with one or more binding molecules specific for one or more of biomarkers comprising at least one of biomarkers M1, M2, M3, M4, M5, or M6, and detecting quantity, presence, or absence of the biomarker in the sample, wherein the quantity, presence or absence of the biomarker allows for the diagnosis of the subject as healthy, as having colorectal cancer, non-malignant disease of the large intestine, precancerous lesion of the large intestine, localized colorectal cancer, metastasised colorectal cancer, or having acute or chronic inflammation of the large intestine. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

Another aspect of the present invention includes a kit for a diagnosis of colorectal cancer within a subject comprising a solution, one or more binding molecules, a detection substrate, and instructions, wherein the instructions outline any of the above methods.

Aspects of the present invention include biomarkers M1, M2, M3, M4, M5, and M6.

Another aspect of the present invention includes the use of any one or more of biomarkers selected from the group of biomarkers M1, M2, M3, M4, M5, and/or M6 in a diagnosis or treatment of any of the diseases or disorders mentioned above. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, MS and M6 can be used.

Another aspect of the present invention includes the use of the detection or quantification of any one or more of biomarkers selected from the group of biomarkers M1, M2, M3, M4, M5, and/or M6 in a biological sample from a subject to determine whether the subject has colorectal cancer. The detection or quantification of any one or more of biomarkers M1, M2, M3, M4, M5, and/or M6 may also be used to determine whether the subject has non-malignant disease of the large intestine. In addition, the detection or quantification of any one or more of biomarkers selected from the group of biomarkers M1, M2, M3, M4, M5, and/or M6 may also be used to determine whether the subject has a non-malignant disease of the large intestine, precancerous lesions of the large intestine, localized colorectal cancer, metastasised colorectal cancer, or acute or chronic inflammation of the large intestine. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used In an embodiment, M1, M2, M3, M4, M5 and M6 can be used.

Another aspect of the present invention includes a database containing a plurality of database entries useful in a diagnosis of subjects as having, or not having, colorectal cancer, comprising categorizing each database entry as either characteristic of having or not having colorectal cancer, and a characterization of each database entry as either having, or not having, or having in a certain quantity, one or more of biomarkers M1, M2, M3, M4, M5, and/or M6. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

A database can be generated by obtaining reference biological samples from subjects known to have, and patients known not to have, colorectal cancer; contacting the reference biological samples with a biologically active surface; allowing biomarkers within the reference biological samples to bind to the biologically active surface; detecting bound biomarkers using a detection method wherein the detection method generates mass profiles of said reference biological samples; transforming the mass profiles into a computer readable form; and applying a mathematical algorithm to classify the mass profiles as specific for healthy subjects or subjects having colorectal cancer.

Another aspect of the present invention includes the use of any one, two, three, four, five, or six biomarkers selected from the group of biomarkers M1, M2, M3, M4, M5, and/or M6 to detect any of the diseases or disorders mentioned above, including colorectal cancer. Preferably, more than one of such biomarkers is used. In an embodiment, M1 and M4 can be used. In an embodiment, M1 and M5 can be used. In an embodiment, M1 and M6 can be used. In an embodiment, M3 and M2 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

Another aspect of the present invention includes a method for identifying a molecular entity that inhibits or promotes an activity of any one or more of biomarkers M1, M2, M3, M4, M5, and/or M6 comprising selecting a control animal having said biomarker and a test animal having said biomarker, treating said test animal using a molecular entity or a library of molecular entities, under conditions to allow specific binding and/or interaction, and determining a relative quantity of the biomarker, as between the control animal and the test animal. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

Animals useful in the methods of the invention include mammals, for example, mice or rats.

Another aspect of the present invention provides a method for identifying a molecular entity that inhibits or promotes an activity of any one or more of biomarkers M1, M2, M3, M4, M5, and/or M6 comprising the steps of selecting a host cell expressing the biomarker; cloning the host cell; separating the clones into a test group and a control group; treating the test group using the molecular entity or a library of molecular entities under conditions to allow specific binding and/or interaction; and determining a relative quantity of the biomarker, as between the test group and the control group. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

Another aspect of the present invention includes a method of identifying a molecular entity that inhibits or promotes an activity of any one or more biomarkers M1, M2, M3, M4, M5, and/or M6, comprising the steps of selecting a test group having a host cell expressing the biomarker and a control group; treating the test group using the molecular entity or a library of molecular entities; and determining a relative quantity of the biomarker, as between the test group and the control group. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

A host cell can be a cancer cell.

A library of molecular entities may be a library of DNA molecules, RNA molecules, peptides, proteins, agonists, antagonists, monoclonal antibodies, immunoglobulins, small molecule drugs, pharmaceutical agents, or a combination thereof.

A further aspect of the present invention includes a composition for treating a disease of the large intestine comprising a molecular entity, which modulates any one or more of biomarkers M1, M2, M3, M4, M5, and/or M6, and a pharmaceutically acceptable carrier. A disease of the large intestine may be colorectal cancer or a non-malignant disease of the large intestine. A disease of the large intestine may be a non-malignant disease of the large intestine, a precancerous lesion of the large intestine, localized colorectal cancer, metastasised colorectal cancer, or acute or chronic inflammation of the large intestine. The molecular entity may be a nucleotide, an oligonucleotide, polynucleotide, amino acid, peptide, polypeptide, protein, antibody, immunoglobulin, small organic molecule, pharmaceutical agent, agonist, antagonist, derivative, or a combination thereof. Preferably, more than one of such biomarkers is used. In an embodiment, M1 and M4 can be used. In an embodiment, M1 and M5 can be used. In an embodiment, M1 and M6 can be used. In an embodiment, M3 and M4 can be used. In an embodiment, M3 and M5 can be used. In an embodiment, M3 and M6 can be used. In an embodiment, M2 and M4 can be used. In an embodiment, M2 and M5 can be used. In an embodiment, M2 and M6 can be used. In an embodiment, M1, M2, M3, M4, M5 and M6 can be used.

A further aspect of the invention includes a composition as described above for treating a subject having a disease of the large intestine. Within the context of the invention, a disease of the large intestine may be colorectal cancer or a non-malignant disease of the large intestine. A disease of the large intestine may be a non-malignant disease of the large intestine, precancerous lesion of the large intestine, localized colorectal cancer, metastasised colorectal cancer, or acute or chronic inflammation of the large intestine.

A further aspect of the present invention includes a composition for treating a subject having a disease of the large intestine comprising any composition identified by any of the above methods, and a pharmaceutically acceptable carrier. A disease of the large intestine may be colorectal cancer or a non-malignant disease of the large intestine. A disease of the large intestine may also be a non-malignant disease of the large intestine, a precancerous lesion of the large intestine, a localized colorectal cancer intestine, a metastasised colorectal cancer of the large intestine, or an acute or chronic inflammation of the large intestine the large intestine. The molecular entity may be a nucleotide, an oligonucleotide, polynucleotide, amino acid, peptide, polypeptide, protein, antibody, immunoglobulin, small organic molecule, pharmaceutical agent, agonist, antagonist, derivative, or a combination thereof.

Another aspect of the present invention is the use of any of the compositions described above for treating a subject having a disease of the large intestine. A disease of the large intestine may be colorectal cancer or a non-malignant disease of the large intestine. A disease of the large intestine may also be a non-malignant disease of the large intestine, a precancerous lesion of the large intestine, a localized colorectal cancer, a metastasised colorectal cancer, or an acute or chronic inflammation of the large intestine.

An aspect of the invention includes a method of determining a stage of colorectal cancer by obtaining a sample from a subject; and measuring a quantity of M1 or M2 or M3 or a derivative and M4 or M5 or M6 or derivatives. The quantity of M1 or M2 or M3 or a derivative and M4 or M5 or M6, or derivatives, above or below a pre-determined cut-off level is indicative of the stage of colorectal cancer.

An aspect of the invention includes methods of classifying a stage of colorectal cancer. For example, a method comprises: a) determining a quantity of (1) M1 or M2 or M3 or a derivative and (2) M4 or MS or M6 or a derivative in a sample; b) comparing a level of (1) M1 or M2 or M3 or a derivative and (2) M4 or MS or M6 or a derivative to a biomarker reference panel (for example, a reference panel which can be mean values of the quantities for the biomarker constituents of the panel for a specific stage); and c) classifying a tumor by said comparison.

### BRIEF DESCRIPTION OF THE FIGURES

FIG. 1. Scatter-plot analyses of peak intensities of several colorectal cancer biomarkers and patient age. Biomarkers examined here include (A) MCR-A61, (B) MCR-6A3, (C) MCR-573, (D) MCR-A42, (E) MCR-425, and (F) MCR-CBE Despite the apparent peak intensity increase with age for some biomarkers (for example, panel C), regression analysis using linear, exponential, power and logarithmic models did not identify significant correlations between peak intensity and age for any of these biomarkers. Red diamonds: CRCa samples. Black squares: non-CRCa samples (benign disease and controls).

FIG. 2. Classification methodology for CRCa based on validated serum biomarkers. A diagnostic model was derived using FCCC samples as a training set by selecting a peak intensity cutoff for a primary biomarker (M2) that gave a sensitivity of ˜90% in the training sample population. Those patients on the side of this cutoff representing ˜10% of all CRCa patients were given a non-CRCa diagnosis. A secondary biomarker (M6) was then used to further classify the remaining patients in the training population to give the model depicted. The performance of this model was evaluated on a naïve sample set obtained from FCCC.

### DETAILED DESCRIPTION OF THE INVENTION

### Definitions

The term “biomolecule” refers to a molecule that is produced by a cell or tissue in an organism. Such molecules include, but are not limited to, molecules such as nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, and combinations thereof (e.g., glycoproteins, ribonucleoproteins, lipoproteins). Furthermore, the terms “nucleotide”, “oligonucleotide” or polynucleotide” refer to DNA or RNA of genomic or synthetic origin which may be single-stranded or double-stranded and may represent a sense or an antisense strand. Included as part of the definition of “oligonucleotide” and “polynucleotide” are peptide polynucleotide sequences (i.e. peptide nucleic acids; PNAs), or any DNA-like or RNA-like material (i.e. Morpholinos, Ribozymes).

The phrase “molecular entity” refers to any defined inorganic or organic molecule that is either naturally occurring or is produced synthetically. Such molecules include, but are not limited to, biomolecules as described above, simple and complex molecules, acids and alkalis, alcohols, aldehydes, arenas, amides, amines, esters, ethers, ketones, metals, salts, and derivatives of any of the aforementioned molecules.

The term “fragment” refers to a portion of a polynucleotide or polypeptide sequence that comprises at least 15 consecutive nucleotides or 5 consecutive amino acid residues, respectively. Furthermore, these “fragments” typically retain the biological activity and/or some functional characteristics of the parent polypeptide e.g. antigenicity or structural domain characteristics.

The term “derivative” refers to a modified form of a biomarker and can include biomarkers M1, M2, M3, M4, M5, and M6. A modified form of a given biomarker may include at least one amino acid substitution, deletion, or insertion, wherein said modified form retains a biological activity of an unmodified form. An amino acid substitution may be considered “conservative” when the substitution results in similar structural or chemical properties (e.g., replacement of leucine with isoleucine). An amino acid substitution may be “non-conservative” in nature wherein the structure and chemical properties vary (e.g., replacement of arginine with alanine). A modified form of a given biomarker may include chemical modifications, wherein a modified form retains a biological activity of a given biomarker. Such modifications include, but are not limited to, glycosylation, phosphorylation, acetylation, alkylation, methylation, biotinylation, glutamylation glycylation, isoprenylation, lipoylation, pegylation, phosphopantetheinylation, sulfation, selenation, and C-terminal amidation. Other modifications include those involving other proteins such as ISGylation, SUMOylation, and ubiquitination. In addition, modifications may also include those involved in changing the chemical nature of an amino acid such as deimination and deamidation.

The term “derivative of prothrombin” refers to an amino acid sequence less than the full sequence of prothrombin as shown in SEQ ID No: 1, or an amino acid sequence with at least 70% identity to SEQ ID No: 1. Preferably the derivative comprises an amino acid sequence with at least 80% identity to SEQ ID No: 1. Preferably the derivative comprises an amino acid sequence with at least 90% identity to SEQ ID No: 1. More preferably the derivative comprises an amino acid sequence with at least 95% identity to SEQ ID No: 1. More preferably the derivative comprises an amino acid sequence with at least 98% identity to SEQ ID No: 1. Even more preferably the derivative comprises an amino acid sequence with at least 99% identity to SEQ ID No: 1. The derivative may be a variant of SEQ ID No 1, such as a prothrombin bearing one or more amino acid substitutions, deletions or insertions, preferably less than five amino acid substitutions, deletions, or insertion.

The phrases “biological sample” and “test sample” refer to all biological fluids and excretions isolated from any given subject. In the context of the invention such samples include, but are not limited to, blood, serum, plasma, urine, semen, seminal fluid, seminal plasma, pre-ejaculatory fluid (Cowper's fluid), nipple aspirate, vaginal fluid, excreta, tears, saliva, sweat, biopsy, ascites, cerebrospinal fluid, lymph, marrow, hair, or tissue extract samples.

The term “host cell” refers to a cell that has been transformed or transfected, or is capable of transformation or transfection by an exogenous polynucleotide sequence. It is understood that such terms refer not only to a particular subject cell but also to a progeny or potential progeny of such a cell. Since certain modifications may occur in succeeding generations due to either mutation or environmental influences, such progeny may not, in fact, be identical to the parent cell, but are still included within the scope of the term as used herein. A host cell can be a cancer cell.

The phrase “specific binding” refers to an interaction between two biomolecules that occur under specific conditions. The binding is specific when one biomolecule adheres to a specific biomolecule and not other biomolecules. Binding between two biomolecules is considered to be specific when the signal of the peak representing the biomolecule is at least twice that of the signal arising from the coincidental detection of non-biomolecule associated ions in approximately the same mass range, which is the peak as a signal to noise ratio of at least two. Moreover, the phrase “specific conditions” refers to reaction conditions that permit, enable, or facilitate the binding of said molecules such as pH, salt, detergent and other conditions known to those skilled in the art.

The term “interaction” refers to direct or indirect binding or alteration of a biological activity of a biomolecule.

The term “differential diagnosis” refers to a diagnostic decision between healthy and different disease states, including various stages of a specific disease. A subject is diagnosed as healthy or to be suffering from a specific disease, or a specific stage of a disease based on a set of hypotheses that allow for a distinction between healthy and one or more stages of the disease. A choice between healthy and one or more stages of disease depends on a significant difference between each hypothesis. Under the same principle, a “differential diagnosis” may also refer to a diagnostic decision between one disease type as compared to another (e.g. colorectal cancer vs. a non-malignant disease of the large intestine).

The term “colorectal cancer” refers to a malignant neoplasm of the large intestine within a given subject, wherein the neoplasm is of epithelial origin and is also referred to as a carcinoma of the large intestine. According to the invention, colorectal cancer is defined according to its type, stage, and/or grade. Typical staging systems such as the Gleason Score (a measure of tumour aggressiveness based on pathological examination of tissue biopsy), the Jewett-Whitmore system, and the TNM system (the system adopted by the American Joint Committee on Cancer and the International Union Against Cancer). The term “colorectal cancer”, when used without qualification, includes both localized and metastasised colorectal cancer. The term “colorectal cancer” can be qualified by the terms “localized” or “metastasised” to differentiate between different types of tumour as those words are defined herein. The terms “colorectal cancer” and “malignant disease of the large intestine” are used interchangeably herein.

Stages of colorectal cancer refer to a) Stage 0: Tis, N0, M0: the cancer is in the earliest stage. It has NOT grown beyond the inner layer (mucosa) of the colon or rectum. This stage is also known as carcinoma in situ or intramucosal carcinoma, b) Stage I: T1, N0, M0 or T2, N0, M0: the cancer has grown through the muscularis mucosa into the submucosa or it may also have grown into the muscularis propria, but it has not spread into nearby lymph nodes or distant sites, c) Stage IIA: T3, N0, M0: the cancer has grown through the wall of the colon or rectum into the outermost layers. It has not yet spread in the nearby lymph nodes of or distant sites d) Stage IIB: T4, N0, M0: the cancer has grown through the wall of the colon or rectum into other nearby tissues or organs. It has not yet spread in the nearby lymph nodes of or distant sites, e) Stage IIIA: T1-2, N1, M0: the cancer has grown through the mucosa into the submucosa or it may also have grown into the muscularis propria, and it has spread to 1-3 nearby lymph nodes but not distant sites, f) Stage IIIB: T3-4, N1, M0: the cancer has grown through the wall of the colon or rectum or into other nearby tissues or organs, and has spread to 1-3 nearby lymph nodes but not distant sites g) Stage IIIC: Any T, N2, M0: the cancer can be any T but has spread to four or more nearby lymph nodes but not distant sites h) Stage IV: Any T, Any N, M1: the cancer can be any T, any N, but has spread to distant sites such as the liver, lung, peritoneum (the membrane lining the abdominal cavity), or ovary.

The terms “neoplasm” or “tumour” may be used interchangeably and refer to an abnormal mass of tissue wherein the growth of the mass surpasses and is not coordinated with the growth of normal tissue. A neoplasm or tumour may be defined as “benign” or “malignant” depending on the following characteristics: degree of cellular differentiation including morphology and functionality, rate of growth, local invasion and metastasis. A “benign” neoplasm is generally well differentiated, has characteristically slower growth than a malignant neoplasm and remains localised to the site of origin. In addition a benign neoplasm does not have the capacity to infiltrate, invade or metastasise to distant sites. A “malignant” neoplasm is generally poorly differentiated (anaplasia), has characteristically rapid growth accompanied by progressive infiltration, invasion, and destruction of the surrounding tissue. Furthermore, a malignant neoplasm has the capacity to metastasise to distant sites.

The term “differentiation” refers to the extent that parenchymal cells resemble comparable normal cells, both morphologically and functionally.

The term “metastasis” refers to the spread or migration of cancerous cells from a primary (original) tumour to another organ or tissue, and is typically identifiable by the presence of a “secondary tumour” or “secondary cell mass” of the tissue type of the primary (original) tumour and not of that of the organ or tissue in which the secondary (metastatic) tumour is located. For example, a colorectal cancer that has migrated to bone is said to be metastasised colorectal cancer, and consists of cancerous colorectal cancer cells in the large intestine as well as cancerous colorectal cancer cells growing in bone tissue.

The phrase “large intestine” refers to a portion of the gastrointestinal tract that functions in absorbing water and electrolytes, as well as the elimination of feces. Large intestines include a cecum, an ascending colon, a transverse colon, a descending colon, a sigmoid colon, a rectum and an anal canal.

The phrases “a non-malignant disease of the large intestine”, “non-colorectal cancer state” and “non-malignant disease of the large intestine” may be used interchangeably and refer to a disease state of the large intestine that has not been classified as colorectal cancer according to specific diagnostic methods including but not limited to faecal occult blood tests (FOBT), flexible sigmoidoscopy (FS), barium enema X-ray (BE), double-contrast barium enema (DCBE), colonoscopy, virtual colonoscopy (VC) and faecal DNA testing (Hendon & DiPalma, 2005; Huang et al., 2005). Such diseases include, but are not limited to an inflammation of large intestinal tissue (e.g., inflammatory bowel disease including Crohn's disease and ulcerative colitis).

The phrase “healthy” refers to a subject possessing good health. Such a subject demonstrates an absence of any malignant or non-malignant disease of the large intestine. In the context of this application, a “healthy individual” is only healthy in that they have an absence of any malignant or non-malignant disease of the large intestine; a “healthy individual” may have other diseases or conditions that would normally not be considered “healthy”.

The phrase “pre-cancerous lesion of the large intestine” or “precancerous lesion of the large intestine lesion” refers to a biological change within the large intestine such that it becomes susceptible to the development of a malignant neoplasm. More specifically, a pre-cancerous lesion of the large intestine is a preliminary stage of a colorectal cancer. Causes of a pre-cancerous lesion may include, but are not limited to, genetic predisposition and exposure to cancer-causing agents (carcinogens); such cancer causing agents include agents that cause genetic damage and induce neoplastic transformation of a cell.

The phrase “neoplastic transformation of a cell” refers an alteration in normal cell physiology and includes, but is not limited to, self-sufficiency in growth signals, insensitivity to growth-inhibitory (anti-growth) signals, evasion of programmed cell death (apoptosis), limitless replicative potential, sustained angiogenesis, and tissue invasion and metastasis.

The phrase “differentially present” refers to differences in the quantity of a biomolecule present in samples taken from colorectal cancer patients as compared to samples taken from subjects having a non-malignant disease of the large intestine or healthy subjects. Furthermore, a biomolecule is differentially present between two samples if the quantity of said biomolecule in one sample population is significantly different (defined statistically) from the quantity of said biomolecule in another sample population. For example, a given biomolecule may be present at elevated, decreased, or absent levels in samples of taken from subjects having colorectal cancer compared to those taken from subjects who do not have a colorectal cancer.

The term ‘biological activity’ may be used interchangeably with the terms ‘biologically active’, ‘bioactivity’ or ‘activity’ and, for the purposes herein, refers to an effector or antigenic function that is directly or indirectly performed by a biomarker (whether in its native or denatured conformation), derivative, or fragment thereof. Effector functions include phosphorylation (kinase activity) or activation of other molecules, induction of differentiation, mitogenic or growth promoting activity, signal transduction, immune modulation, DNA regulatory functions and the like, whether presently known or inherent. Antigenic functions include possession of an epitope or antigenic site that is capable of cross-reacting with antibodies raised against a naturally occurring or denatured biomarker of the invention, derivative or fragment thereof. Accordingly, a biological activity of such a protein can be that it functions as regulator of a signalling pathway of a target cell. Such a signalling pathway can, for example, modulate cell differentiation, proliferation and/or migration of such a cell, as well as tissue invasion, tumour development and/or metastasis. A target cell according to the invention can be a cancer cell.

The terms ‘neoplastic cell’ and ‘neoplastic tissue’ refer to a cell or tissue, respectively, that has undergone transformation, which is manifested by an escape from specific control mechanisms, increased growth potential, alteration in the cell surface, karyotypic abnormalities, morphological and biochemical deviations from the norm, and other attributes conferring the ability to invade, metastasise and kill.

The term “diagnostic assay” can be used interchangeably with “diagnostic method” and refers to the detection of the presence or nature of a pathologic condition. Diagnostic assays differ in their sensitivity and specificity, and their relative usefulness as a diagnostic tool can be measured using ROC-AUC statistics.

Within the context of the invention, the term “true positives” refers to those subjects having a localized or a metastasised colorectal cancer or a non-malignant disease of the large intestine, a precancerous lesion of the large intestine, or an acute or a chronic inflammation of the large intestine and are categorized as such by a diagnostic assay. Depending on context, the term “true positives” may also refer to those subjects having either colorectal cancer or a non-malignant disease of the large intestine, and who are categorized as such by the diagnostic assay.

Within the context of the invention, the term “false negatives” refers to those subjects having either a localized or a metastasised colorectal cancer, a non-malignant disease of the large intestine, a precancerous lesion of the large intestine, or an acute or a chronic inflammation of the large intestine, and are not categorized as such by a diagnostic assay. Depending on context, the term “false negatives” may also refer to those subjects having either colorectal cancer or a non-malignant disease of the large intestine, and who are not categorized as such by the diagnostic assay.

Within the context of the invention, the term “true negatives” refers to those subjects who do not have a localized or a metastasised colorectal cancer, a non-malignant disease of the large intestine, a precancerous lesion of the large intestine, or an acute or a chronic inflammation of the large intestine, and who are categorized as such by a diagnostic assay. Depending on context, the term “true negatives” may also refer to those subjects who do not have colorectal cancer or a non-malignant disease of the large intestine and who are categorized as such by the diagnostic assay.

Within the context of the invention, the term “false positives” refers to those subjects who do not have a localized or a metastasised colorectal cancer, a non-malignant disease of the large intestine, a precancerous lesion of the large intestine, or an acute or a chronic inflammation of the large intestine but are categorized by a conventional diagnostic assay as having a localized or metastasised colorectal cancer, a non-malignant disease of the large intestine, a precancerous lesion of the large intestine or an acute or chronic inflammation of the large intestine. Depending on context, the term “false positives” may also refer to those subjects who do not have colorectal cancer or a non-malignant disease of the large intestine but are categorized by a diagnostic assay as having colorectal cancer or a non-malignant disease of the large intestine.

The term “sensitivity”, as used herein in the context of its application to diagnostic assays, refers to the proportion of all subjects with localized or metastasised colorectal cancer, a non-malignant disease of the large intestine, a precancerous lesion of the large intestine, or an acute or a chronic inflammation of the large intestine that are correctly identified as such (that is, the number of true positives divided by the sum of the number of true positives and false negatives).

The term “specificity” of a diagnostic assay, as used herein in the context of its application to diagnostic assays, refers to the proportion of all subjects with neither localized or metastasised colorectal cancer nor non-malignant disease of the large intestine, a precancerous lesion of the large intestine, or an acute or a chronic inflammation of the large intestine that are correctly identified as such (that is, the number of true negatives divided by the sum of the number of true negatives and false positives).

The term “adsorbent” refers to any material that is capable of accumulating (binding) a given biomolecule. The adsorbent typically coats a biologically active surface and comprises a single material or a plurality of different materials that are capable of binding a biomolecule. Such materials include, but are not limited to, anion exchange materials, cation exchange materials, metal chelators, polynucleotides, oligonucleotides, peptides, antibodies, naturally occurring compounds, synthetic compounds, etc.

The phrase “biologically active surface” refers to any two- or three-dimensional extensions of a material that biomolecules can bind to, or interact with, due to the specific biochemical properties of this material and those of the biomolecules. Such biochemical properties include, but are not limited to, ionic character (charge), hydrophobicity, or hydrophilicity.

The phrase “binding biomolecule” refers to a molecule that displays an affinity for another biomolecule.

The term “immunogen” may be used interchangeably with the phrase “immunising agent” and refers to any substance or organism that provokes an immune response when introduced into the body of a given subject. All immunogens are considered as antigens and, in the context of the invention, can be defined on the basis of their immunogenicity, wherein “immunogenicity” refers to the ability of the immunogen to induce either a humoral or a cell-mediated immune response. In the context of the invention an immunogen that induces a “humoral immune response” activates antibody production and secretion by cells of the B-lymphocyte lineage (B-cells) and thus can be used to for antibody production as described herein. Such immunogens may be polysaccharides, proteins, lipids, or nucleic acids, or they may be lipids or nucleic acids that are complexed to either a polysaccharide or a protein.

The term “solution” refers to a homogeneous mixture of two or more substances. Solutions may include, but are not limited to buffers, substrate solutions, elution solutions, wash solutions, detection solutions, standardisation solutions, chemical solutions, solvents, etc.

The phrase “coupling buffer” refers to a solution that is used to promote covalent binding of biomolecules to a biological surface.

The phrase “blocking buffer” refers to a solution that is used to block unbound binding sites of a given biological surface from interacting with biomolecules in an unspecific manner.

The term “chromatography” refers to a method of separating biomolecules within a given sample such that an original native state of a given biomolecule is retained. Separation of a biomolecule from other biomolecules within a given sample for the purpose of enrichment, purification an or analysis may be achieved by methods including, but not limited to, size exclusion chromatography, ion exchange chromatography, hydrophobic and hydrophilic interaction chromatography, metal affinity chromatography, wherein “metal” refers to metal ions (e.g. nickel, copper, gallium, zinc, iron or cobalt) of all chemically possible valences, or ligand affinity chromatography wherein “ligand” refers to binding molecules, preferably proteins, antibodies, or DNA. Generally, chromatography uses biologically active surfaces as adsorbents to selectively accumulate certain biomolecules.

The phrase “mass spectrometry” refers to a method comprising employing an ionisation source to generate gas phase ions from a biological entity of a sample presented on a biologically active surface, and detecting the gas phase ions with an ion detector. Comparison of the time gas phase ions take to reach an ion detector from the moment of ionisation with a calibration equation derived from at least one molecule of known mass allows the calculation of the estimated mass to charge ratio of the ion being detected.

The phrases “mass to charge ratio”, “m/z ratio” or “m/z” can be used interchangeably and refer to the ratio of the molecular weight (grams per mole) of an ion detected by mass spectrometry to the number of charges the ion carries. Thus a single biomolecule can be assigned more than one mass to charge ratio by a mass spectrometer if that biomolecule can be ionised into more than one species each of which carries a different number of charges.

The acronym “TOF” refers to the time-of-flight of a biomolecule or other molecular entity, particularly that of an ion in a time-of-flight type mass spectrometer. TOF values are derived by measuring the duration of flight of an ion, typically between its entry into and exit from a time-of-flight analyser tube. In an embodiment, the accuracy of TOF values can be improved by methods known to those skilled in the art, for example through the use of reflectrons and/or pulsed-laser ionisation. TOF values for a given ion can be applied to previously established calibration equations derived from the TOF values for ions of known mass in order to calculate the mass to charge ratio of these ions.

The phrase “calibration equation” refers to a standard curve based on the TOF of biomolecules with known molecular mass. Application of a calibration equation to peaks in a mass spectrum allows the calculation of the m/z ratio of these peaks based on their observed TOF.

The phrase “laser desorption mass spectrometry” refers to a method comprising the use of a laser as an ionisation source to generate gas phase ions from a biomolecule presented on a biologically active surface, and detecting the gas phase ions with a mass spectrometer.

The term “mass spectrometer” refers to a gas phase ion spectrometer that includes an inlet system, an ionisation source, an ion optic assembly, a mass analyser, and a detector.

Within the context of the invention, the terms “detect”, “detection” or “detecting” refer to the identification of the presence, absence, or quantity of a given biomolecule.

The phrase “Mann-Whitney Rank Sum Test” refers to a non-parametric statistical method used to test the null hypothesis that two sets of values that do not have normal distributions are derived from the same population.

The phrase “energy absorbing molecule” and its acronym “EAM” refers to a molecule that absorbs energy from an energy source in a mass spectrometer thereby enabling desorption of a biomolecule from a biologically active surface. Cinnamic acid derivatives, sinapinic acid and dihydroxybenzoic acid, ferulic acid and caffeic acid are frequently used as energy-absorbing molecules in laser desorption of biomolecules. See U.S. Pat. No. 5,719,060 for a further description of energy absorbing molecules.

The terms “peak” and “signal” may be used interchangeably, and refer to a defined, non-background value which is generated by a population of a given biomolecule of a certain molecular mass that has been ionised contacting the detector of a mass spectrometer, wherein the size of the population can be roughly related to the degree of the intensity of the signal. Typically, this “signal” can be defined by two values: an apparent mass-over-charge ratio (m/z) and an intensity value generated as described.

The phrases “peak intensity”, “intensity of a peak” and “intensity” may be used interchangeably, and refer to the relative amount of a biomolecule contacting the detector of a mass spectrometer in relation to other peaks in the same mass profile. Typically, the intensity of a peak is expressed as the maximum observed signal within a defined mass range that adequately defines the peak.

The phrases “signal to noise ratio”, “SN ratio” and “SN” may be used interchangeably, and refer to the ratio of a peak's intensity and a dynamically calculated value representing the average background signal detected in the approximate mass range of the peak. The SN ratio of a peak is typically used as an objective criterion for (a) computer-assisted peak detection and/or (b) manual evaluation of a peak as being an artefact.

The term “cluster” refers to a peak that is present in a certain set of mass spectra or mass profiles obtained from different samples belonging to two or more different groups (e.g. subjects with colorectal cancer and healthy subjects). Within the set of spectra, the peaks or signals belonging to a given cluster can differ in their intensities, but not in the apparent molecular masses.

The term “classifier” refers to an algorithm or methodology that is using one or more defined traits or attributes to subdivide a population individual patients or samples or elements of data into a finite number of groups with as great a degree of accuracy as possible.

The term “tree” refers to a type of classifier consisting of a branching series of decision points (typically referred to as “leaves” or “nodes”) that eventually lead to a classification of individual patients or samples or elements of data from a population into one of a finite number of groups.

The phrase “mass profile” refers to a series of discrete, non-background noise peaks that are defined by their mass to charge ratio and are characteristic of an individual mass spectrum.

The acronym “ROC-AUC” refers to the area under a receiver operator characteristic curve. This is a widely accepted measure of diagnostic utility of some tool, taking into account both the sensitivity and specificity of the tool. Typically, ROC-AUC ranges from 0.5 to 1.0, where a value of 0.5 indicates the tool has no diagnostic value and a value of 1.0 indicates the tool has 100% sensitivity and 100% specificity.

The term “sensitivity” refers to the proportion of patients with the outcome in whom the results of the decision rule are abnormal. Typically, the outcome is disadvantageous to the patient. The term “specificity” refers to the proportion of patients without the outcome in whom the results of the decision rule are normal.

The phrase “biomarker M1”, “peak M1”, “biomolecule M1” and “molecular entity M1” are used interchangeably herein and refer to a peak with an apparent time of flight of 21.85 μS, and/or m/z ratio 3932.42. Error ranges for both peak and TOF values are cited in Table 1. Moreover, the biomarker comprises an amino acid sequence encoding prothrombin as shown in SEQ ID No: 1, derivatives and fragments thereof.

The phrase “biomarker M2”, “peak M2”, “biomolecule M2” and “molecular entity M2” are used interchangeably herein and refer to a peak with an apparent time of flight of 24.79 μS, and/or m/z ratio 5062.85. Error ranges for both peak and TOF values are cited in Table 1.

The phrase “biomarker M3”, “peak M3”, “biomolecule M3” and “molecular entity M3” are used interchangeably herein and refer to a peak with an apparent time of flight of 26.10 μS, and/or m/z ratio 5615.04. Error ranges for both peak and TOF values are cited in Table 1. Moreover, the biomarker comprises an amino acid sequence encoding prothrombin as shown in SEQ ID No. 1, derivatives and fragments thereof.

The phrase “biomarker M4”, “peak M4”, “biomolecule M4” and “molecular entity M4” are used interchangeably herein and refer to a peak with an apparent time of flight of 37.2 μS, and/or m/z ratio 11430.65, Error ranges for both peak and TOF values are cited in Table 1.

The phrase “biomarker M5”, “peak M5”, “biomolecule M5” and “molecular entity M5” are used interchangeably herein and refer to a peak with an apparent time of flight of 37.43 μS, and/or m/z ratio 11541.25. Error ranges for both peak and TOF values are cited in Table 1.

The phrase “biomarker M6”, “peak M6”, “biomolecule M6” and “molecular entity M6” are used interchangeably herein and refer to a peak with an apparent time of flight of 37.65 μS, and/or m/z ratio 11678.05. Error ranges for both peak and TOF values are cited in Table 1.

The phrases “prothrombin”, “thrombin”, “coagulation factor II”, “Factor II”, and “F2”, are used interchangeably herein, and refer to the protein having the amino acid sequence of SEQ ID No: 1.

TABLE 1
Definition of peaks in terms of mass and time-of-flight (TOF) parameters.
Mass is given in g/mol and all times are given in microseconds (μS).

| | Mass (g/mol) | | TOF (μS) | |
|---|---|---|---|---|
| Peak Name | ±95% CI | ±99% CI | ±95% CI | ±99% CI |
| M1 | 3931.92 ± 4.26 | 3931.92 ± 5.60 | 21.85 ± 0.018 | 21.85 ± 0.024 |
| M2 | 5062.41 ± 4.05 | 5062.41 ± 5.32 | 24.79 ± 0.017 | 24.79 ± 0.022 |
| M3 | 5614.56 ± 3.4 | 5614.56 ± 4.47 | 26.10 ± 0.014 | 26.10 ± 0.018 |
| M4 | 11428.72 ± 8.02 | 11428.72 ± 10.55 | 37.25 ± 0.017 | 37.25 ± 0.023 |
| M5 | 11539.69 ± 4.8 | 11539.69 ± 6.31 | 37.43 ± 0.016 | 37.43 ± 0.021 |
| M6 | 11676.54 ± 5.14 | 11676.54 ± 6.75 | 37.65 ± 0.017 | 37.65 ± 0.023 |

Although any materials and methods, or equipment comparable to those specifically described herein can be used to practice or test the present invention, the preferred equipment, materials and methods are described below. All publications mentioned herein are cited for the purpose of describing and disclosing protocols, reagents, and current state of the art technologies that might be used in connection with the invention, and are incorporated herein by reference. Nothing herein is to be construed as an admission that the invention is not entitled to precede such disclosure by virtue of prior invention.

### For Use as a Diagnostic Tool

The present invention relates to methods for differential diagnosis of colorectal cancer or a non-malignant disease of the large intestine by detecting one or more differentially expressed biomolecule(s) within a biological sample of a given subject, comparing results with samples from healthy subjects, subjects having a non-malignant disease of the large intestine and subjects having colorectal cancer, wherein the comparison allows for the differential diagnosis of a subject as healthy, having non-malignant disease of the large intestine or having colorectal cancer.

In one aspect of the invention, a method for the differential diagnosis of colorectal cancer or a non-malignant disease of the large intestine comprises: obtaining a biological sample from a given subject, contacting said sample with an adsorbent present on a biologically active surface under specific binding conditions, allowing the biomolecules within the biological sample to bind to said adsorbent, detecting one or more bound biomolecules using a detection method, wherein the detection method generates a mass profile of said sample, transforming the mass profile generated into a computer-readable form, and comparing the mass profile of said sample with a database containing mass profiles from comparable samples specific for healthy subjects, subjects having colorectal cancer, and/or subjects having a non-malignant disease of the large intestine. The outcome of said comparison will allow for the determination of whether the subject from which the biological sample was obtained, is healthy, has a non-malignant disease of the large intestine and/or colorectal cancer based on the presence, absence or comparative quantity of specific biomolecules.

In more than one embodiment, a single biomolecule or a combination of more than one biomolecule selected from the group of biomarkers M1, M2, M3, M4, M5, and M6 may be detected within a given biological sample. Detection of a single or a combination of more than one biomolecule of the invention is based on specific sample pre-treatment conditions, the pH of binding conditions, the adsorbent used on the biologically active surface, and the calibration equation used to determine the TOF of the given biomolecules.

In one aspect of the invention, biomolecules comprise a biomarker M1, M2, M3, M4, M5, or M6 and may be used individually to diagnose a subject as being healthy, or having a non-malignant disease of the large intestine, or having a precancerous lesion of the large intestine, or having a localized colorectal cancer, or having a metastasised colorectal cancer, or having an acute or a chronic inflammation of the large intestine. In another aspect of the invention, the biomolecules comprising M1, M2, M3, M4, M5, or M6 may be used in combination or combinations with one another to diagnose a subject as being healthy, or having of a non-malignant disease of the large intestine, or having a precancerous lesion of the large intestine, or having a localized colorectal cancer, or having a metastasised colorectal cancer, or having an acute or a chronic inflammation of the large intestine. For example, a biomarker M1 may be used in combination with one or more biomarkers comprising at least one of biomarkers M2, M3, M4, M5 or M6 to diagnose a subject as being healthy, or having of a non-malignant disease of the large intestine or having a precancerous lesion of the large intestine or having a localized colorectal cancer or having a metastasised colorectal cancer of the large intestine or having an acute or a chronic inflammation of the large intestine. To further clarify the preceding example, biomarker M1 may be used together with biomarker M3 to differentially diagnose a subject as being healthy, or having of a non-malignant disease of the large intestine, or having a precancerous lesion of the large intestine, or having a localized colorectal cancer, or having a metastasised colorectal cancer, or having an acute or a chronic inflammation of colorectal tissue. Furthermore, biomarker M1 may also be used together with biomarkers M3 and M4 to differentially diagnose a subject as being healthy, having a non-malignant disease of the large intestine, or having colorectal cancer. In addition, biomarker M2 may also be used together with biomarkers M3, M4, M5 and M6 to differentially diagnose a subject as being healthy, or having of a non-malignant disease of the large intestine, or having a precancerous lesion of the large intestine, or having a localized colorectal cancer, or having a metastasised colorectal cancer, or having an acute or a chronic inflammation of colorectal tissue. This preceding disclosure is intended for clarity only and is not intended to limit the scope of the invention.

In yet another aspect of the invention, biomolecules comprising a biomarker M1, M2, M3, M4, M5, or M6 may be used in combination with another diagnostic tool to diagnose a subject as being healthy, or having a non-malignant disease of the large intestine, or having a precancerous lesion of the large intestine, or having a localized colorectal cancer, or having a metastasised colorectal cancer, or having an acute or a chronic inflammation of colorectal tissue. For example, biomarker M3 may be used in combination with other diagnostic tools specific for colorectal cancer detection such as, but not limited to, large intestine specific antigen testing, DRE, rectal palpitation, biopsy evaluation using Gleason scoring, radiography and symptomological evaluation by a qualified clinician.

According to the invention, a biomolecule comprising a biomarker M1, M2, M3, M4, M5, or M6 can be detected by contacting a biological sample with a biologically active surface comprised of an adsorbent comprising cationic, quaternary ammonium groups, and detecting bound biomarkers using mass spectrometry as described in another section.

Methods for detecting biomolecules have many applications. For example, a single biomolecule or a combination of more than one biomolecule comprising a biomarker of M1, M2, M3, M4, M5, or M6 can be measured to differentiate between healthy subjects, subjects having a non-malignant disease of the large intestine, subjects having a precancerous lesion of the large intestine, or subjects having a localized colorectal cancer, or subjects having a metastasised colorectal cancer, or subjects with an acute or a chronic inflammation of colorectal tissue, and thus are useful as an aid in the diagnosis of a non-malignant disease of the large intestine, or a precancerous lesion of the large intestine, or a localized colorectal cancer, or a metastasised colorectal cancer, or an acute or a chronic inflammation of colorectal tissue. In an embodiment, said biomolecules may be used to diagnose a subject as being healthy.

For example, biomarker M1 may be present only in biological samples from patients having colorectal cancer. Mass profiling of two biological samples from different subjects, X and Y, can reveal the presence of biomarker M1 in a sample from test subject X, and the absence of the same biomarker in a test sample from subject Y. The medical practitioner can diagnose subject X as having colorectal cancer and subject Y as not having colorectal cancer.

In yet another example, four biomarkers M4, M5, M2 and M6 can be present in varying quantities in samples specific for benign prostatic hyperplasia (BPH) and colorectal cancer. Biomarker M4 can be present in more samples specific for BPH than for colorectal cancer. Biomarker M5 is detected only in samples from subjects having colorectal cancer but not in those having BPH, whereas biomarker M2 is present in about the same quantity in both sample types. Such biomarkers are not present in samples from healthy subjects, only Biomarker M6. Analysis of a biological sample can reveal the presence of biomarkers M4, M5 and M2. Comparison of the quantity of the biomarkers within said sample can reveal that biomarker M5 is present at higher levels than biomarker M4. The medical practitioner can diagnose the test subject as having colorectal cancer. These disclosures are solely used for the purpose of clarification and are not intended to limit the scope of this invention.

In another aspect of the invention, an in vitro binding assay can be used to detect a biomolecule comprising a biomarker M1, M2, M3, M4, M5, or M6 within a biological sample of a given subject. A given biomolecule of the invention can be detected within a biological sample by contacting the biological sample from a given subject with specific binding molecule(s) under conditions conducive for an interaction between the given binding molecule(s) and a biomolecule comprising at least one of biomarker M1, M2, M3, M4, M5, or M6. If a given biomolecule is present in the biological sample, it will form a complex with its binding molecule. To determine if the quantity of the detected biomolecule in a biological sample is comparable to a given quantity for healthy subjects, subjects having a non-malignant disease of the large intestine, subjects having a precancerous lesion of the large intestine, subjects having a localized colorectal cancer, subjects having a metastasised colorectal cancer or subjects with an acute or a chronic inflammation of colorectal tissue, the amount of the complex formed between the binding molecule and a biomolecule comprising at least one of biomarkers M1, M2, M3, M4, M5, and/or M6 can be determined by comparing to a standard. For example, if the amount of the complex falls within a quantitative value for healthy subjects, then the sample can be considered to be obtained from a healthy subject. If the amount of the complex falls within a quantitative value for subjects known to have a non-malignant disease of the large intestine, then the sample can be considered to be obtained from a subject having a non-malignant disease of the large intestine. If the amount of the complex falls within a quantitative range for subjects known to have colorectal cancer, then the sample can be considered to have been obtained from a subject having colorectal cancer. In vitro binding assays that are included within the scope of the invention are well known (e.g., ELISA, western blotting).

Thus, an embodiment of the invention provides a method for the differential diagnosis of colorectal cancer or non-malignant disease of the large intestine comprising: detecting of one or more differentially expressed biomolecules comprising a biomarker M1, M2, M3, M4, M5, or M6 within a given biological sample. This method comprises obtaining a biological sample from a subject, contacting said sample with a binding molecule specific for a differentially expressed biomolecule, detecting an interaction between the binding molecule and its specific biomolecule, wherein the detection of an interaction indicates the presence or absence of said biomolecule, thereby allowing for a differential diagnosis of a subject as healthy, or having a non-malignant disease of the large intestine, or having a precancerous lesion of the large intestine, or having a localized colorectal cancer, or having a metastasised colorectal cancer, or having an acute or a chronic inflammation of colorectal tissue. Binding molecules include, but are not limited to, nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, compounds, synthetic molecules or combinations thereof. (e.g. glycoproteins, ribonucleoproteins, lipoproteins). Preferably, binding molecules can be antibodies specific for at least one of the biomarkers M1, M2, M3, M4, M5, or M6. Biomolecules detected using the above-mentioned binding molecules include, but are not limited to, molecules comprising nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, and combinations thereof (e.g., glycoproteins, ribonucleoproteins, lipoproteins). Preferably, biomolecules that are detected using the above-mentioned binding molecules include, nucleic acids, nucleotides, oligonucleotides, polynucleotides, amino acids, peptides, polypeptides, proteins, monoclonal and/or polyclonal antibodies. Even more preferred are binding molecules that are amino acids, peptides, polypeptides, proteins, monoclonal and/or polyclonal antibodies.

For example, in vivo antibodies or fragments thereof may be utilised for detecting a biomolecule comprising a biomarker M1, M2, M3, M4, M5, or M6 in a biological sample comprising: applying a labelled antibody specific for a biomolecule comprising a biomarker M1, M2, M3, M4, M5, or M6 to a biological sample under conditions that favour an interaction between the labelled antibody and its corresponding biomolecule. Depending on the nature of the biological sample, it is possible to determine not only the presence of a biomolecule, but also its cellular distribution. For example, in a blood serum sample, only the serum levels of a given biomolecule can be detected, whereas its level of expression and cellular localisation can be detected in histological samples. A wide variety of methods can be modified in order to achieve such detection.

In another example, an antibody specific for a biomolecule comprising biomarkers M1, M2, M3, M4, M5, or M6 that is coupled to an enzyme is detected using a chromogenic substrate that is recognised and cleaved by the enzyme to produce a chemical moiety that is readily detected using spectrometric, fluorimetric or visual means. Enzymes used to for labelling include, but are not limited to, malate dehydrogenase, staphylococcal nuclease, delta-5-steroid isomerase, yeast alcohol dehydrogenase, alpha-glycerophosphate, dehydrogenase, triose phosphate isomerase, horseradish peroxidase, alkaline phosphatase, asparaginase, glucose oxidase, beta-galactosidase, ribonuclease, urease, catalase, glucose-6-phosphate dehydrogenase, glucoamylase and acetylcholinesterase. Detection may also be accomplished by visual comparison of the extent of the enzymatic reaction of a substrate with that of similarly prepared standards. In an embodiment, radiolabelled antibodies can be detected using a gamma or a scintillation counter, or they can be detected using autoradiography. In another example, fluorescently labelled antibodies are detected based on the level at which the attached compound fluoresces following exposure to a given wavelength. Fluorescent compounds typically used in antibody labelling include, but are not limited to, fluorescein isothiocynate (FITC), rhodamine, phycoerthyrin, phycocyanin, allophycocyani, o-phthaldehyde and fluorescamine. In yet another example, antibodies coupled to a chemi- or bioluminescent compound can be detected by determining the presence of luminescence. Such compounds include, but are not limited to, luminal, isoluminal, theromatic acridinium ester, imidazole, acridinium salt, oxalate ester, luciferin, luciferase and aequorin.

Furthermore, in vivo techniques for detecting a biomolecule comprising a biomarker M1, M2, M3, M4, M5, or M6 include introducing into a subject a labelled antibody specific for biomolecule(s) comprising a biomarker M1, M2, M3, M4, M5, or M6.

In addition, methods of the invention for the differential diagnosis of healthy subjects, subjects having a non-malignant disease of the large intestine, subjects having a precancerous lesion of the large intestine, subjects having a localized colorectal cancer, subjects having a metastasised colorectal cancer and/or subjects having an acute or chronic inflammation of the large intestine, described herein, may be combined with other diagnostic methods to improve the outcome of the differential diagnosis. Other diagnostic methods are well known.

As shown in an example above (for the differentiation of colorectal cancer from benign large intestine hyperplasia), a method of the invention can also be used for a differential diagnosis of healthy subjects, subjects having a precancerous lesion of the large intestines, subjects having a non-malignant disease of the large intestine, subjects having a localized colorectal cancer, subjects having metastasised colorectal cancer, and/or subjects having acute or chronic inflammation of the large intestine.

In general, for an equivalent number of patients categorized (i.e., for a data set of the same size), one would expect a database divided into three classes (healthy, having non-malignant disease of the large intestine, having colorectal cancer) to have a greater diagnostic accuracy when used for diagnosing patients, as compared to a database divided into six classes (healthy, having non-malignant disease of the large intestine, having localized colorectal cancer, having metastasised colorectal cancer, having precancerous lesion of the large intestines, and having acute or chronic inflammation of the large intestine). One would also reasonably expect that an increase in the data characterized (i.e., number of patients entered into the database) would result in an improvement in the diagnostic accuracy of the database. Embodiments of the invention can also be used for the differential diagnosis of any two or more of the six classes described herein.

One would also expect, in general, that a database utilizing all 6 biomolecules of the invention (M1, M2, M3, M4, M5, and M6 with apparent TOF's of 21.85, 24.79, 26.10, 37.25, 37.43, 37.65 μS respectively) would have greater sensitivity and specificity than a database utilizing only one or two of these biomolecules. For example, to differentiate between non-malignant disease of the large intestine and colorectal cancer, a database utilizing just one biomolecule (biomarker M1) may be enough to have acceptable sensitivity and specificity, whereas a larger number of biomolecules may be necessary to differentiate between, for example, colorectal cancer and a non-malignant disease of the large intestine.

Biomolecules detected in a given biological sample using diagnostic methods are further described herein.

Binding molecules used to detect biomolecules are further described herein.

Biological samples used in diagnostic methods are described herein.

### Database

In another aspect of the invention, a database comprising mass profiles specific for healthy subjects and subjects having a non-malignant disease of the large intestine or colorectal cancer can be generated by contacting biological samples isolated from said subjects with an adsorbent on a biologically active surface under specific binding conditions, allowing the biomolecules within said sample to bind said adsorbent, detecting one or more bound biomolecules using a detection method wherein the detection method generates a mass profile of said sample, transforming the mass profile data into a computer-readable form and applying a mathematical algorithm to classify the mass profile as specific for healthy subjects, subjects having a non-malignant disease of the large intestine and colorectal cancer.

In an embodiment, a mass profile specificity can be further differentiated into patients known to be healthy subjects, subjects with non-malignant disease of the large intestine, subjects with localized colorectal cancer, subjects with metastasised colorectal cancer, subjects having precancerous lesion of the large intestines, and subjects with acute or chronic inflammation of the large intestine.

According to embodiments of the invention, classification of mass profiles can be performed using a mathematical algorithm that assesses a detectable level of biomolecules comprising a biomarker M1, M2, M3, M4, M5, or M6, either in conjunction with or independent of other clinical parameters, to correctly categorize an individual sample as originating from a healthy patient, a patient with a non-malignant disease of the large intestine or a patient with colorectal cancer, or, as described above, to further categorize an individual sample as originating from a healthy subject, having a non-malignant disease of the large intestine, a subject having a localized colorectal cancer, a subject having a metastasised colorectal cancer, a subject having precancerous lesion of the large intestine, or a subject with acute or chronic inflammation of the large intestine.

In general, for an equivalent number of patients categorized (i.e., for a data set of the same size), one would expect a database divided into three classes (healthy, having non-malignant disease of the large intestine, having colorectal cancer) to have a greater diagnostic accuracy as compared to a database divided into six classes (healthy, having non-malignant disease of the large intestine, having localized colorectal cancer, having metastasised colorectal cancer, having precancerous lesion of the large intestines, and having acute or chronic inflammation of the large intestine). One would also reasonably expect that an increase in the data characterized (i.e., number of patients entered into the database) would result in an improvement in the diagnostic accuracy of the database. In another aspect of the invention, a database of mass spectrometric profiles obtained from patients of known diagnoses can be used to provide a comparative training set of spectra for use in the diagnosis of an unknown sample from which a test mass spectrometric profile has been obtained. For example, such a diagnostic method would compare biomolecules comprising a biomarker M1, M2, M3, M4, M5, or M6 detected in a test mass spectrometric profile with those retained in a database in order to identify a training mass spectrometric profile(s) to which the test mass spectrometric profile is most similar. By taking a weighted majority vote of the training profile(s) thus identified a diagnosis of the sample from which the test mass spectrometric profile was derived can be made.

In more than one embodiment, one or more biomolecules comprising biomarkers M1, M2, M3, M4, M5, and M6 may be detected within a given biological sample. Detection of said biomolecules can be based on the type of biologically active surface used for detecting biomolecules within a given biological sample. Biomolecules can bind to an adsorbent on a biologically active surface under specific binding conditions following direct application of a given sample to the given biologically active surface. For example, a given sample is applied to a biologically active surface comprising an adsorbent consisting of cationic quaternary ammonium groups and the biomolecules within the given sample that are detected using mass spectrometry.

Biomolecules detected in a given biological sample for the purpose of generating a database are further described herein.

Biological samples used in diagnostic methods are described herein.

Biological samples used to generate a database of mass profiles for healthy subjects, subjects having a non-malignant disease of the large intestine, and those having colorectal cancer are described herein.

Biological samples used to generate a database of mass profiles for healthy subjects, subjects having non-malignant disease of the large intestine, subjects having localized colorectal cancer, subjects having metastasised colorectal cancer, subjects having precancerous lesion of the large intestines, and those subjects having acute or chronic inflammation of the large intestine, are described herein.

### Molecules of the Invention

Differential expression of biomolecules in samples from healthy subjects, subjects having a non-malignant disease of the large intestine, and subjects having colorectal cancer allows for a differential diagnosis of colorectal cancer or a non-malignant disease of the large intestine within a given subject. Accordingly, biomolecules characterized herein can be isolated and further characterized using standard laboratory techniques, and used to determine novel treatments for colorectal cancer and non-malignant disease of the large intestine. Knowledge of the association of these biomolecules with colorectal cancer and non-malignant disease of the large intestine can be used, for example, to treat patients with the biomolecule, an antibody specific to the biomolecule, or an antagonist of the biomolecule.

Biomolecules are said to be specific for a particular clinical state (e.g., healthy, a precancerous lesion of the large intestine, a non-malignant disease of the large intestine, localized colorectal cancer, metastasised colorectal cancer, acute or chronic inflammation of the large intestine) when the biomolecules are present at different levels within samples taken from subjects in one clinical state compared to samples taken from subjects from other clinical states (e.g., in subjects with a non-malignant disease of the large intestine versus in subjects with colorectal cancer). Biomolecules may be present at elevated levels, at decreased levels, or altogether absent within a sample taken from a subject in a particular clinical state (e.g., healthy, non-malignant disease of the large intestine, colorectal cancer). The following hypothetical example is used for further clarity only, and is not be construed as an admission of the invention: biomolecules M3 and M6 can be found at elevated levels in samples isolated from healthy subjects compared to samples isolated from subjects having a malignant disease of the large intestine, or a colorectal cancer. Whereas, biomolecules M4, M1, M5 can be found at elevated levels and/or more frequently in samples isolated from subjects having colorectal cancer compared to subjects in good health, or having a non-malignant disease of the large intestine. Biomolecules M3 and M6 are said to be specific for healthy subjects, whereas biomolecules M4, M1, and M5 are specific for subjects having colorectal cancer.

Accordingly, differential presence of one or more biomolecules comprising a biomarker M1, M2, M3, M4, M5, or M6 found in a given biological sample provides useful information regarding a probability of whether a subject being tested has a non-malignant disease of the large intestine, colorectal cancer or is healthy. A probability that a subject being tested has a non-malignant disease of the large intestine, colorectal cancer or is healthy depends on whether the quantity of one or more biomolecules comprising a biomarker M1, M2, M3, M4, M5, or M6 in a test sample taken from said subject is statistically significant from a quantity of one or more biomolecules comprising a biomarker M1, M2, M3, M4, M5, or M6 in a biological sample taken from healthy subjects, subjects having a non-malignant disease of the large intestine or subjects having colorectal cancer.

In addition, differential presence of one or more biomolecules comprising a biomarker M1, M2, M3, M4, M5, or M6 found in a given biological sample may be used to predict whether a subject will develop a colorectal cancer, localised cancer of the large intestine, or a metastasised colorectal cancer. The quantity of one of more biomolecules comprising a biomarker M1, M2, M3, M4, MS or M6 detected in a sample taken from a subject compared to a reference biomarker panel indicative of healthy, non-malignant disease of the large intestine, precancerous lesion of the large intestines, localised colorectal cancer, metastasised colorectal cancer, acute inflammation of the large intestine or chronic inflammation of the large intestine. Additionally, reference biomarker panels indicative of familial colorectal cancer would also be utilised for comparison. The probability that a subject being tested will develop a non-malignant disease of the large intestine, colorectal cancer or is healthy depends on whether a quantity of one or more biomolecules comprising a biomarker M1, M2, M3, M4, M5, or M6 in a test sample taken from said subject is statistically significant from a quantity of one or more biomolecules comprising a biomarker M1, M2, M3, M4, M5, or M6 in a biological sample taken from healthy subjects, subjects having a non-malignant disease of the large intestine or subjects having colorectal cancer, as well as subjects having a history of familial cancer. Based on the comparison, a prediction of whether said subject will develop colorectal cancer, localised cancer of the large intestine, or a metastasised colorectal cancer can be made.

A differential presence of one or more biomolecules comprising a biomarker M1, M2, M3, M4, M5, or M6 found in a given biological sample may also be used to determine whether a subject known to have a colorectal cancer, localised cancer of the large intestine, or a metastasised colorectal cancer is responding to a therapeutic treatment being administered. A quantity of one of more said biomarkers detected in a sample taken at time of therapy is compared to a quantity of one of more said biomarkers detected in a sample taken prior to an administration of treatment. In addition, a quantity of one or more said biomarkers detected in a sample taken at time of therapy is compared to a reference biomarker panel indicative of healthy, non-malignant disease of the large intestine, precancerous lesion of the large intestines, localised colorectal cancer, metastasised colorectal cancer, acute inflammation of the large intestine or chronic inflammation of the large intestine. Based on a comparison, one can determine whether said subject is responding to a therapeutic treatment, and to what degree the response is.

Furthermore, a differential presence of one or more biomolecules comprising a biomarker M1, M2, M3, M4, M5, or M6 found in a given biological sample may also be used to determine whether a subject known to have a colorectal cancer, localised cancer of the large intestine, or a metastasised colorectal cancer will respond to a given therapeutic treatment. A quantity of one or more said biomarkers detected in a sample taken from a subject diagnosed as having a colorectal cancer, localised cancer of the large intestine, or a metastasised colorectal cancer is compared to reference biomarker panels taken from subjects with similar diagnoses that have undergone different forms of treatment. Reference biomarker panels generated from samples taken from subjects exposed to a given treatment, wherein the treatment resulted in a positive outcome are considered to indicate that the given treatment had a positive effect on the subject and therefore would be deemed successful. Reference biomarker panels generated from samples taken from subjects exposed to a given treatment, wherein the treatment resulted in a neutral outcome are considered to indicate that the given treatment had no therapeutic effect on the subject and would therefore be deemed unsuccessful. Reference biomarker panels generated from samples taken from subjects exposed to a given treatment, wherein the treatment resulted in a negative outcome are considered to indicate that the given treatment had no therapeutic effect on the subject and would be deemed unsuccessful. Based on the comparison, one skilled in the art would be able to administer the best mode of treatment for said subject.

Additionally, differential presence of one or more biomolecules comprising a biomarker M1, M2, M3, M4, M5, or M6 found in a given biological sample may also be used to determine the stage of colorectal cancer, localised cancer of the large intestine, or a metastasised colorectal cancer in a subject. A quantity of one or more said biomarkers detected in a sample taken from a subject diagnosed as having a colorectal cancer, localised cancer of the large intestine, or a metastasised colorectal cancer is compared to reference biomarker panels taken from subjects known to have a specific stage or grade of colorectal cancer, localised cancer of the large intestine, or a metastasised colorectal cancer. Based on the comparison, one would be able to determine the stage or grade at which the colorectal cancer, localised cancer of the large intestine, or a metastasised colorectal cancer is present within said subject.

The biomolecules of the invention comprise a biomarker M1, M2, M3, M4, M5, or M6, can be produced by a cell or living organism, and may have any biochemical property (e.g. phosphorylated proteins, glycosylated proteins, positively charged molecules, negatively charged molecules, hydrophobicity, hydrophilicity), but preferably biochemical properties that allow binding of the biomolecules to a biologically active surface of the invention as described herein. Such biomolecules include, but are not limited to nucleic acids, nucleotides, oligonucleotides, polynucleotides (DNA or RNA), amino acids, peptides, polypeptides, proteins, monoclonal and/or polyclonal antibodies, antigens, sugars, carbohydrates, fatty acids, lipids, steroids, hormones and combinations thereof (e.g., glycoproteins, ribonucleoproteins, lipoproteins). Preferably a biomolecule may be a nucleic acid, nucleotide, oligonucleotide, polynucleotide (DNA or RNA), amino acid, peptide, polypeptide, protein or fragments thereof. Even more preferred are amino acids, peptides, polypeptides or protein biomolecules or fragments thereof.

Binding molecules include, but are not limited to, nucleic acids, nucleotides, oligonucleotides, polynucleotides (DNA or RNA), amino acids, peptides, polypeptides, proteins, monoclonal and/or polyclonal antibodies, antigens, sugars, carbohydrates, fatty acids, lipids, steroids, hormones, and combinations thereof (e.g., glycoproteins, ribonucleoproteins, lipoproteins), compounds or synthetic molecules. Preferably, binding molecules are specific for any biomolecule comprising a biomarker M1, M2, M3, M4, M5, or M6.

### Screening for Therapeutics

Differential expression of biomolecules may be the result of an aberrant expression of said biomolecules at either the genomic (e.g., gene amplification), transcriptomic (e.g., increased mRNA), or proteomic levels (i.e. translation, post-translational modifications etc.) within a given subject. Whereas aberrant over-expression of a biomolecule may be regulated using agents that inhibit its biological activity and/or biological expression, aberrant under-expression of a given biomolecule may be regulated using agents that can promote its biological activity or biological expression. Such agents can be used to treat a subject known to have colorectal cancer and are, therefore, referred to as therapeutic agents.

Embodiments of the invention provide methods for screening therapeutic agents for treating colorectal cancer resulting from aberrant expression of a biomolecule comprising a biomarker M1, M2, M3, M4, M5, or M6. Methods identify agents (e.g. peptides, peptidomimetics, small molecules or other drugs), or candidate test molecules or compounds, which may decrease or increase expression of a biomolecule comprising a biomarker M1, M2, M3, M4, M5, or M6.

Furthermore, embodiments of the invention provide methods for screening therapeutic agents for treating colorectal cancer resulting from aberrant expression of a biomolecule comprising a biomarker M1, M2, M3, M4, M5, or M6. The methods identify candidates, test molecules or compounds, or agents (e.g. peptides, peptidomimetics, small molecules or other drugs), which may decrease or increase the biological activity of a biomolecule selected from the group of biomarkers M1, M2, M3, M4, M5, and M6.

Agents capable of interacting directly or indirectly with a biomolecule selected from the group of biomarkers M1, M2, M3, M4, M5, and M6, can be identified by various methods. For example, such agents can be identified using methods based on various binding assays (see references on: yeast-2-hybrid (Bemis et al., 1995; Fields & Sternglanz, 1994; Topcu & Borden, 2000); yeast 3 hybrid: (Zhang et al., 1999); GST pull-downs (Palmer et al., 1998); and phage display (Scott & Smith, 1990)).

One embodiment provides assays for screening agents that bind to, interact with, or modulate a biologically active form of a biomolecule comprising a biomarker M1, M2, M3, M4, M5, or M6. Agents can be obtained using any of the numerous known approaches in combinatorial library methods, including: biological libraries, aptially addressable parallel solid phase or solution phase libraries, synthetic library methods requiring deconvolution, the ‘one-bead-one-compound’ library method, and synthetic library methods using affinity chromatography selection. The biological library approach is limited to peptide libraries, while the other four approaches are applicable to peptide, non-peptide oligomer or small molecule libraries of compounds (Bindseil et al., 2001; Grabley et al., 2000; Houghten et al., 2000; Rader, 2001).

Examples of methods for the synthesis of molecular libraries are well known, for example, (DeWitt, Erb, Gallop and Gordon).

Libraries of agents may be presented in solution (Houghten, 1992), or on beads (Lam et al., 1991), chips (Fodor et al., 1993), bacteria (U.S. Pat. No. 5,223,409), spores (U.S. Pat. Nos. 5,571,698; 5,403,484; and 5,223,409), plasmids (Cull et al., 1992) or phages (Scott and Smith, 1990; Devlin et al., 1990; Cwirla et al., 1990; Felici et al., 1991).

In one embodiment, an assay is a cell-based assay in which a cell expresses a biomolecule comprising a biomarker M1, M2, M3, M4, M5, or M6. The expressed biomarker is contacted with an agent or a library of agents and the ability of the agent to bind to, or interact with, a polypeptide is determined. The cell can, for example, be a eucaryotic cell such as, but not limited to a yeast cell, an invertebrate cell (e.g. C. elegans), an insect cell, a teleost cell, an amphibian cell, or a cell of mammalian origin. Determining an ability of an agent to bind to, or interact with a biomolecule of the invention can be accomplished, for example, by coupling an agent with a radioisotope (e.g., ¹²⁵, ³⁵S, ¹⁴C, or ³H) or enzymatic label (e.g., horseradish peroxidase, alkaline phosphatase, or luciferase) such that binding or interaction of the agent to a biomolecule can be determined by detecting the labelled agent in the complex. Methods of labelling and detecting interactions of agents with a biomolecule are well known.

In a preferred embodiment, an assay comprises contacting a cell, that expresses a biomolecule comprising a biomarker M1, M2, M3, M4, M5, or M6, with a known agent which binds or interacts with a biomolecule comprising a biomolecule M1, M2, M3, M4, M5, or M6 to form an assay mixture, contacting the assay mixture with a test agent, and determining the ability of the test agent to bind to or interact with a biomolecule of the invention, wherein determining the ability of the test agent to bind or interact with a biomolecule is compared to a control biomolecule. Determination of the ability of a test agent to bind to or interact with a biomolecule comprising a biomarker M1, M2, M3, M4, M5, or M6 is based on competitive binding/inhibition kinetics of the test agent and known target agent for a given biomolecule. Methods of detecting competitive binding or the interaction of two molecules for the same target, wherein the target is a biomolecule comprising a biomarker M1, M2, M3, M4, M5, or M6, are well known.

In another embodiment, an assay is a cell-based assay comprising contacting a cell expressing a biologically active biomolecule comprising a biomarker M1, M2, M3, M4, M5, or M6, with a test agent and determining the ability of the test agent to inhibit a biological activity of a biomolecule comprising a biomarker M1, M2, M3, M4, M5, or M6. This can be accomplished, for example, by determining whether a biomolecule comprising a biomarker M1, M2, M3, M4, M5, or M6 continues to bind to or interact with a known target molecule, or whether a specific cellular function (e.g. ion-channelling) has been abrogated. For example, a target molecule can be a component of a signal transduction pathway that facilitates transduction of an extracellular signal, a second intercellular protein that has a catalytic activity, a protein that regulates transcription of specific genes, or a protein that initiates protein translation. Determining the ability of a biologically active biomolecule comprising a biomarker M1, M2, M3, M4, M5, or M6, to bind to or interact with a target molecule can be accomplished by determining the activity of the target molecule. For example, an activity of a target molecule can be determined by detecting induction of a cellular second messenger of the target (e.g., intracellular Ca²⁺, diacylglycerol, and inositol triphosphate (IP3)), detecting catalytic/enzymatic activity of the target on an appropriate substrate, detecting the induction (via a regulatory element that may be responsive to a given polypeptide) of a reporter gene operably linked to a polynucleotide encoding a detectable marker (e.g., β-galactosidase, luciferase, green fluorescent protein (GFP), enhanced green fluorescent protein (EGFP), Ds-Red fluorescent protein, far-red fluorescent protein (Hc-red), secreted alkaline phosphatase (SEAP), chloramphenicol acetyltransferase (CAT), neomycin, etc.), or detecting a cellular response, for example, cellular differentiation, proliferation or migration.

In yet another embodiment, an assay can be a cell-free assay comprising contacting a biologically active biomolecule comprising a biomarker M1, M2, M3, M4, M5, or M6, with a test agent, and determining the ability of the test agent to bind to or interact with any one of the biomolecules. Binding or interaction of a test agent to a biomolecule can be determined either directly or indirectly as described above. In a preferred embodiment, an assay includes contacting any one of the biomolecules comprising a biomarker M1, M2, M3, M4, M5, or M6 with a known agent, that binds or interacts with said biomolecule to form an assay mixture. An assay mixture is contacted with a test agent, and a determination of the ability of the test agent to interact with the polypeptide is based on competitive binding/inhibition kinetics of the test agent and known agents for a given biomolecule. Methods of detecting competitive binding, or interaction, of two agents for the same biomolecule are well known, wherein the biomolecule comprises at least one of biomarkers M1, M2, M3, M4, M5, and M6.

In another embodiment, an assay is a cell-free assay comprising contacting a biologically active biomolecule comprising a biomarker M1, M2, M3, M4, M5, or M6, with a test agent, and determining the ability of the test agent to inhibit an activity of a given biomolecule. Determining the ability of the test agent to inhibit an activity of a biomolecule can be accomplished, for example, by determining the ability of a biomolecule to bind to a target molecule by one of the methods described herein for determining direct binding. In an alternative embodiment, determining the ability of the test agent to modulate an activity of a given biomolecule can be accomplished by determining the ability of a given biomolecule to further modulate a target molecule.

In embodiments of the assay methods, it may be desirable to immobilize biomarkers M1, M2, M3, M4, M5 or M6 or its target molecule to facilitate separation of complexed from uncomplexed forms of one or both of the biomolecules, as well as to accommodate automation of the assay. Binding of a test agent to a biomolecule comprising a biomarker M1, M2, M3, M4, M5, or M6, or interaction of a given biomolecule selected from the group of biomarkers M1, M2, M3, M4, M5, and M6 with a target molecule in the presence and absence of a candidate compound, can be accomplished in any vessel suitable for containing reactants. Examples of such vessels include microtitre plates, test tubes, and micro-centrifuge tubes. In one embodiment, a fusion protein can be provided which adds a domain that allows one or both of the proteins to be bound to a matrix. For example, glutathione-S-transferase fusion proteins can be adsorbed onto glutathione sepharose beads (Sigma Chemical, St. Louis, Mo.) or glutathione derivatised microtitre plates, which are then combined with the test agent and either the non-adsorbed target protein or a biologically active biomolecule comprising a biomarker M1, M2, M3, M4, M5, or M6. The mixture can be incubated under conditions conducive to complex formation (e.g., at physiological conditions for salt and pH). Following incubation, the beads or microtitre plate wells can be washed to remove any unbound components, and complex formation can be measured either directly or indirectly, for example, as described above. In an embodiment, complexes can be dissociated from a matrix, and the level of binding or activity of a polypeptide can be determined using standard techniques.

Other techniques for immobilizing biomolecules on matrices can also be used in the screening assays of the invention. For example, a biologically active biomolecule selected from the group of biomarkers M1, M2, M3, M4, M5, and M6, or its target molecule can be immobilized utilizing conjugation of biotin and streptavidin.

In another embodiment, inhibitors of expression of a biomolecule comprising a biomarker M1, M2, M3, M4, M5, or M6 are identified in a method in which cells are contacted with a candidate agent and/or library of candidate agents, and the expression of a selected mRNA or protein (i.e., the mRNA or protein corresponding to a biomolecule comprising at least one of biomarkers M1, M2, M3, M4, M5, and M6 or a biologically active biomolecule of the invention) in a cell is determined. In a preferred embodiment, the cell is an animal cell. Even more preferred, the cell can be derived from an insect, fish, amphibian, mouse, rat, or human. The level of expression of a selected mRNA or protein in the presence of a candidate agent is compared to the level of expression of the selected mRNA or protein in the absence of a candidate agent. A candidate agent can be identified as a inhibitor of expression of a given biomolecule comprising a biomarker M1, M2, M3, M4, M5, or M6 based on this comparison. For example, when expression of a selected mRNA or protein is less (statistically significant) in the presence of a candidate agent than in its absence, the candidate agent is identified as an inhibitor of the selected mRNA or protein expression. The level of the selected mRNA or protein expression in the cells can be determined by methods described herein.

Those test agents identified in the above-described assays are considered within the context of the invention as specific biomarkers M1, M2, M3, M4, M5 or M6 therapeutic agents.

In another embodiment, a biomarker M1, M2, M3, M4, M5 or M6 therapeutic agent can also be identified by using a reporter assay, in which the level of expression of a reporter construct, under the control of a biomarkers M1, M2, M3, M4, M5 or M6 gene promoter, is measured in the presence or absence of a test agent. A biomarker M1, M2, M3, M4, M5 or M6 promoter can be isolated by screening a genomic library with a cDNA encoding the complete coding sequence for a biomolecule selected from the group of biomarkers M1, M2, M3, M4, M5 or M6; preferably containing the 5′ end of the cDNA. A portion of said promoter, typically from 20 to about 500 base pairs long is then cloned upstream of a reporter gene, e.g., a β-galactosidase, luciferase, green fluorescent protein (GFP), enhanced green fluorescent protein (EGFP), Ds-Red fluorescent protein, far-red fluorescent protein (Hc-red), secreted alkaline phosphatase (SEAP), chloramphenicol acetyltransferase (CAT), neomycin gene, in a plasmid. This reporter construct is then transfected into cells, e.g., mammalian cells. The transfected cells are distributed into wells of a multi-well plate and various concentrations of test molecules or compounds are added to the wells. After several hours of incubation, the level of expression of the reporter construct is determined according to known methods. A difference in the level of expression of the reporter construct in transfected cells incubated with the test molecule or compound relative to transfected cells incubated without the test molecule or compound will indicate that the test molecule or compound is capable of modulating the expression of a gene encoding a biomolecule selected from the group of biomarkers M1, M2, M3, M4, M5, and M6 and is thus a therapeutic agent for a biomolecule selected from the group of biomarkers M1, M2, M3, M4, M5, and M6.

In one embodiment of the invention, therapeutic agents for a biomolecule comprising a biomarker M1, M2, M3, M4, M5, or M6 can be used for treating colorectal cancer, and may be applied to any patient in need of such therapy. Preferably, the patient in need of such therapy is of human origin.

Embodiments of the invention further pertain to novel agents identified by the above-described screening assays and uses thereof for the treatment of a non-steroid dependent cancer as described herein.

### Biological Samples of the Invention

Although said biomolecules were first identified in urine samples, their detection is not limited to said sample type. In more than one embodiment of the invention, biomolecules can be detected in blood, serum, plasma, urine, semen, seminal fluid, seminal plasma, pre-ejaculatory fluid (Cowper's fluid), nipple aspirate, vaginal fluid, excreta, tears, saliva, sweat, biopsy, ascites, cerebrospinal fluid, lymph, or tissue extract (biopsy) samples. Preferably, biological samples used to detect biomolecules are of urine, blood, serum, plasma and excreta.

Furthermore, biological samples used for methods of the invention are isolated from subjects of mammalian origin, preferably of primate origin. Even more preferred are subjects of human origin.

A subject that is said to have colorectal cancer possesses morphological, biochemical, and functional alterations of their colorectal tissue such that the tissue can be characterised as a malignant neoplasm. The stage to which a colorectal cancer has progressed can be determined using known methods currently available (e.g., Union Internationale Contre Cancer (UICC) system or American Joint Committee on Cancer (AJC)). Currently, the most widely used method for determining the extent of malignancy of a colorectal neoplasm is the Gleason Grading system. Gleason grading is based exclusively on the architectural pattern of the glands of a colorectal neoplasm, wherein the ability of neoplastic cells to structure themselves into glands resembling those of the normal large intestine is evaluated using a scale of 1 to 5. For example, neoplastic cells that are able to architecturally structure themselves such that they resemble normal large intestine gland structure are graded 1-2, whereas neoplastic cells that are unable to do so are graded 4-5. A colorectal neoplasm has tumour structure that is nearly normal will tend to behave, biologically, as normal tissue and therefore it is unlikely that it will be aggressively malignant.

A subject that is said to have non-malignant disease of the large intestine possesses morphological and/or biochemical alterations of their colorectal tissue but does not exhibit malignant neoplastic properties. Such diseases include, but are not limited to, inflammatory and proliferative lesions, as well as benign disorders of the large intestine. Within the context of the invention, inflammatory diseases encompass inflammatory bowel diseases including but not limited to Crohn's disease, ulcerative colitis, and proliferative lesions include benign large intestine hyperplasia.

### Biologically Active Surfaces of the Invention

Biologically active surfaces include, but are not limited to, surfaces that contain adsorbents with anion exchange properties (adsorbents that are positively charged), cation exchange properties (adsorbents that are negatively charged), hydrophobic properties, reverse phase chemistry, groups such as nitriloacetic acid that immobilize metal ions such as nickel, gallium, copper, or zinc (metal affinity interaction), or biomolecules such as proteins, antibodies, nucleic acids, or protein binding sequences, covalently bound to the surface via carbonyl diimidazole moieties or epoxy groups (specific affinity interaction).

Biologically active surfaces may be located on matrices like polysaccharides such as sepharose (e.g., anion exchange surfaces or hydrophobic interaction surfaces), or solid metals, (e.g., antibodies coupled to magnetic beads or a metal surface). Surfaces may also include gold-plated surfaces such as those used for BIAcore Sensor Chip technology. Other known surfaces are also included within the scope of the invention.

Biologically active surfaces are able to adsorb biomolecules like nucleotides, nucleic acids, oligonucleotides, polynucleotides, amino acids, polypeptides, proteins, monoclonal and/or polyclonal antibodies, steroids, sugars, carbohydrates fatty acids, lipids, hormones, and combinations thereof (e.g., glycoproteins, ribonucleoproteins, lipoproteins).

In another embodiment, devices that use biologically active surfaces to selectively adsorb biomolecules may be chromatography columns for Fast Protein Liquid Chromatography (FPLC) and High Pressure Liquid Chromatography (HPLC), where the matrix, e.g. a polysaccharide, carrying the biologically active surface, is filled into vessels (usually referred to as “columns”) made of glass, steel, or synthetic materials like polyetheretherketone (PEEK).

In yet another embodiment, devices that use biologically active surfaces to selectively adsorb biomolecules may be metal strips carrying thin layers of a biologically active surface on one or more spots of the strip surface to be used as probes for gas phase ion spectrometry analysis, for example the Sax2 of Q10 ProteinChip array (Ciphergen Biosystems, Inc.) for SELDI analysis.

### Generation of Mass Profiles

In one embodiment, a mass profile of a biological sample may be generated using an array-based assay in which biomolecules of a given sample are bound by biochemical or affinity interactions to an adsorbent present on a biologically active surface located on a solid platform (“chip”). After the biomolecules have bound to the adsorbent, they are co-crystallized with an energy absorbing molecule and subsequently detected using gas phase ion spectrometry. This includes mass spectrometers, ion mobility spectrometers, or total ion current measuring devices. The quantity and characteristics of a biomolecule can be determined using gas phase ion spectrometry. Other substances in addition to biomolecules can also be detected by gas phase ion spectrometry.

In one embodiment, a mass spectrometer can be used to detect a biomolecule(s) on a chip. In a typical mass spectrometer, a chip with a bound biomolecule(s) co-crystallized with an energy absorbing molecule is introduced into an inlet system of a mass spectrometer. The energy absorbing molecule:biomolecule crystals are then ionised by an ionization source, such as a laser. The ions generated are then collected by an ion optic assembly, and then a mass analyser disperses and analyses the passing ions. The ions exiting the mass analyser are then detected by an ion detector. The ion detector then translates the information into mass-to-charge ratios. Detection of the presence of a biomolecule(s) or other substances will typically involve detection of signal intensity. This, in turn, can reflect the quantity and character of a biomolecule bound to the probe.

In another embodiment, a mass profile of a sample may be generated using a liquid-chromatography (LC)-based assay in which biomolecule(s) of a given sample are bound by biochemical or affinity interactions to an adsorbent located in a vessel made of glass, steel, or synthetic material; known to those skilled in the art as a chromatographic column. The biomolecule(s) are eluted from the biologically active adsorbent surface by washing the vessel with appropriate solutions known to those skilled in the art. Such solutions include but are not limited to, buffers, e.g. Tris(hydroxymethyl)aminomethane hydrochloride (TRIS-HCl), buffers containing salt, e.g. sodium chloride (NaCl), or organic solvents, e.g. acetonitrile. Mass profiles of these biomolecules are generated by application of the eluting biomolecules of the sample by direct connection via an electrospray device to a mass spectrometer (LC/ESI-MS).

Conditions that promote binding of a biomolecule(s) to an adsorbent are known to those skilled in the art and ordinarily include parameters such as pH, the concentration of salt, organic solvent, or other competitors for binding of the biomolecule to the adsorbent.

### Detection of Biomolecules of the Invention

In one embodiment, mass spectrometry can be used to detect biomolecules comprising a biomarker M1, M2, M3, M4, M5, or M6 of a given sample. Such methods include, but are not limited to, matrix-assisted laser desorption ionization/time-of-flight (MALDI-TOF), surface-enhanced laser desorption ionization/time-of-flight (SELDI-TOF), liquid chromatography coupled with MS, MS-MS, or ESI-MS. Typically, biomolecules are analysed by introducing a biologically active surface containing said biomolecules, ionising said biomolecules to generate ions that are collected and analysed.

In a preferred embodiment, biomolecules comprising a biomarker M1, M2, M3, M4, M5, or M6 are detected in samples using gas phase ion spectrometry, and more preferably, using mass spectrometry.

In one embodiment, matrix-assisted laser desorption/ionization (“MALDI”) mass spectrometry can be used. In MALDI, the sample is partially purified to obtain a fraction that essentially consists of a biomolecule by employing such separation methods as: two-dimensional gel electrophoresis (2D-gel) or high performance liquid chromatography (HPLC).

In another embodiment, surface-enhanced laser desorption/ionization mass spectrometry (SELDI) can be used to detect a biomolecule(s) comprising a biomarker M1, M2, M3, M4, M5, or M6 uses a substrate comprising adsorbents to capture biomolecules, which can then be directly desorbed and ionised from the substrate surface during mass spectrometry. Since the substrate surface in SELDI captures biomolecules, a sample need not be partially purified as in MALDI. However, depending on the complexity of a sample and the type of adsorbents used, it may be desirable to prepare a sample to reduce its complexity prior to SELDI analysis.

In a preferred embodiment, a laser desorption time-of-flight mass spectrometer is used with the probe of the present invention. In laser desorption mass spectrometry, biomolecules bound to a biologically active surface are introduced into an inlet system. Biomolecules are desorbed and ionised into the gas phase by a laser. The ions generated are then collected by an ion optic assembly. These ions are accelerated through a short high-voltage field and allowed to drift into a high vacuum chamber of a time-of-flight mass analyser. At the far end of the high vacuum chamber, the accelerated ions collide with a detector surface at varying times. Since the time-of-flight is a function of the mass of the ions, the elapsed time between ionization and impact can be used to identify the presence or absence of molecules of a specific mass.

Data analysis can include the steps of determining signal strength (e.g., intensity of peaks) of a biomolecule(s) detected and removing “outliers” (data deviating from a predetermined statistical distribution). An example is the normalization of peaks, a process whereby the intensity of each peak relative to some reference is calculated. For example, a reference can be background noise generated by an instrument and/or a chemical (e.g., energy absorbing molecule), which is set as zero in the scale. Then the signal strength detected for each biomolecule can be displayed in the form of relative intensities in the scale desired (e.g., 100). In an embodiment, an observed signal for a given peak can be expressed as a ratio of the intensity of that peak over the sum of the entire observed signal for both peaks and background noise in a specified mass to charge ratio range. In an embodiment, a standard may be admitted with a sample so that a peak from the standard can be used as a reference to calculate relative intensities of the signals observed for each biomolecule(s) detected.

The resulting data can be transformed into various formats for displaying, typically through the use of computer algorithms. In one format, referred to as a “spectrum view”, a standard spectral view can be displayed, wherein the view depicts the quantity of a biomolecule reaching the detector at each possible mass to charge ratio. In another format, referred to as “scatter plot”, only the intensity and mass to charge information for defined peaks are retained from the spectrum view, yielding a cleaner image and enabling biomolecules with nearly identical molecular mass to be more easily distinguished from one another.

Using any of the above display formats, it can be readily determined from a signal display whether a biomolecule having a particular TOF is detected from a sample. Preferred biomolecules of the invention are biomolecules comprising a biomarkers M1, M2, M3, M4, M5, or M6.

In another aspect of the invention, biomolecules comprising a biomarker M1, M2, M3, M4, M5, or M6 can be detected using other methods known to those skilled in the art. For example an in vitro binding assay can be used to detect a biomolecule of the invention within a biological sample of a given subject. A given biomolecule of the invention can be detected within a biological sample by contacting the biological sample from a given subject with specific binding molecule(s) under conditions conducive for an interaction between the given binding molecule(s) and a biomolecule comprising a biomarker M1, M2, M3, M4, M5, or M6. Binding molecules include, but are not limited to, nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, or combinations thereof. (e.g. glycoproteins, ribonucleoproteins, lipoproteins), compounds or synthetic molecules. Preferably, binding molecules are antibodies specific for any one of the biomolecules selected from the group of biomarkers M1, M2, M3, M4, M5, and M6. The biomolecules detected using the above-mentioned binding molecules include, but are not limited to, molecules comprising nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, and combinations thereof (e.g., glycoproteins, ribonucleoproteins, lipoproteins). Preferably, biomolecules that are detected using the above-mentioned binding molecules include, nucleic acids, nucleotides, oligonucleotides, polynucleotides, amino acids, peptides, polypeptides, proteins, monoclonal and/or polyclonal antibodies. Even more preferred are binding molecules that are amino acids, peptides, polypeptides, proteins, monoclonal and/or polyclonal antibodies.

### Antibodies of the Invention

With respect to protein-based testing, antibodies can be generated to the biomarkers using standard immunological techniques, fusion proteins or synthetic peptides as described herein. Monoclonal antibodies can also be produced using now conventional techniques such as those described in Waldmann (1991) and Harlow and Lane (1988). It will also be appreciated that antibody fragments, i.e. Fab′ fragments, can be similarly employed. Immunoassays, for example ELISAs, in which the test sample is contacted with antibody and binding to the biomarker detected, can provide a quick and efficient method of determining the presence and quantity of the biomarker. For example, the antibodies can be used to test the effect of pharmaceuticals in subjects enrolled in clinical trials.

Thus, embodiments of the invention also provide polyclonal and/or monoclonal antibodies and fragments thereof, and immunologic binding equivalents thereof, which are capable of specifically binding to the biomarkers and fragments thereof. The term “antibody” is used both to refer to a homogeneous molecular entity, or a mixture such as a serum product made up of a plurality of different molecular entities. Polypeptides may be prepared synthetically in a peptide synthesizer and coupled to a carrier molecule (e.g., keyhole limpet hemocyanin) and injected over several months into a host mammal. The host's sera can be tested for immunoreactivity to the subject polypeptide or fragment. Monoclonal antibodies may be made by injecting mice with the protein polypeptides, fusion proteins or fragments thereof. Monoclonal antibodies are screened by ELISA and tested for specific immunoreactivity with subject biomarkers or fragments thereof (Harlow & Lane, 1988). These antibodies are useful in assays as well as pharmaceuticals.

Once a sufficient quantity of desired polypeptide has been obtained, it may be used for various purposes. A typical use is the production of antibodies specific for binding. These antibodies may be either polyclonal or monoclonal, and may be produced by in vitro or in vivo techniques well known in the art. For production of polyclonal antibodies, an appropriate target immune system, typically mouse or rabbit, is selected. Substantially purified antigen is presented to the immune system in a fashion determined by methods appropriate for the animal and by other parameters well known to immunologists. Typical routes for injection are in footpads, intramuscularly, intraperitoneally, or intradermally. Of course, other species may be substituted for mouse or rabbit. Polyclonal antibodies are then purified using techniques known in the art, adjusted for the desired specificity.

An immunological response is usually assayed with an immunoassay. Normally, such immunoassays involve some purification of a source of antigen, for example, that produced by the same cells and in the same fashion as the antigen. A variety of immunoassay methods are well known in the art, such as in Harlow and Lane (1988) or Goding (1996).

Monoclonal antibodies with affinities of 10⁸ M⁻¹ or preferably 10⁹ to 10¹⁰ M⁻¹ or stronger will typically be made by standard procedures as described in Harlow and Lane (1988) or Goding (1996). Briefly, appropriate animals will be selected and the desired immunization protocol followed. After an appropriate period of time, spleens of such animals are excised and individual spleen cells fused, typically, to immortalized myeloma cells under appropriate selection conditions. Thereafter, the cells are clonally separated and the supernatants of each clone tested for their production of an appropriate antibody specific for the desired region of the antigen.

Other suitable techniques involve in vitro exposure of lymphocytes to the antigenic biomarkers, or In an embodiment, to selection of libraries of antibodies in phage or similar vectors (Huse et al., 1989). The polypeptides and antibodies of the present invention may be used with or without modification. Frequently, polypeptides and antibodies will be labelled by joining, either covalently or non-covalently, a substance, which provides for a detectable signal. A wide variety of labels and conjugation techniques are known and are reported extensively in both the scientific and patent literature. Suitable labels include radionuclides, enzymes, substrates, cofactors, inhibitors, fluorescent agents, chemiluminescent agents, magnetic particles and the like. Patents teaching the use of such labels include U.S. Pat. Nos. 3,817,837; 3,850,752; 3,939,350; 3,996,345; 4,277,437; 4,275,149 and 4,366,241. Also, recombinant immunoglobulins may be produced (see U.S. Pat. No. 4,816,567).

### Generation of Monoclonal Antibodies Specific for the Biomarker

Monoclonal antibodies can be generated according to various known methods. For example any technique that provides for production of antibody molecules by continuous cell lines in culture may be used. These include but are not limited to the hybridoma technique originally developed by Kohler and Milstein (1975), as well as the trioma technique, the human B-cell hybridoma technique (Kozbor et al., 1983); (Cote et al., 1983), and the EBV-hybridoma technique to produce human monoclonal antibodies (Cole et al., 1985). In fact, according to the invention, techniques developed for production of “chimeric antibodies” (Morrison et al., 1984; Neuberger et al., 1984; Takeda et al., 1985) by splicing the genes from a mouse antibody molecule specific for a given biomarker of the invention together with genes from a human antibody molecule of appropriate biological activity can be used. Such human or humanized chimeric antibodies are preferred for use in therapy of human diseases or disorders (described infra), since human or humanized antibodies are much less likely than xenogeneic antibodies to induce an immune response, in particular an allergic response, themselves.

The following example of monoclonal antibody production is meant for clarity and is not intended to limit the scope of the invention. One method of producing antibodies of the invention is by inoculating a host mammal with an immunogen comprising an intact subject biomarker or its peptide (wild or mutant). A host mammal may be any mammal and is preferably a host mammal such as a mouse, rat, rabbit, guinea pig or hamster and is most preferably a mouse. By inoculating a host mammal, it is possible to elicit the generation of antibodies directed towards the immunogen introduced into the host mammal. Several inoculations may be required to elicit an immune response.

To determine if the host mammal has developed antibodies directed towards the immunogen, serum samples are taken from the host mammal and screened for the desired antibodies. This can be accomplished by known techniques such as radioimmunoassay, ELISA (enzyme-linked immunosorbent assay), “sandwich” immunoassays, immunoradiometric assays, gel diffusion precipitin reactions, immunodiffusion assays, in situ immunoassays (using colloidal gold, enzyme or radioisotope labels, for example), western blots, precipitation reactions, agglutination assays (e.g., gel agglutination assays, hemagglutination assays), complement fixation assays, immunofluorescence assays, protein A assays, and immunoelectrophoresis assays, etc. In one embodiment, antibody binding is detected by detecting a label on a primary antibody. In another embodiment, a primary antibody is detected by detecting binding of a secondary antibody or reagent to the primary antibody. In a further embodiment, a secondary antibody is labelled.

Once antibody generation is established in a host mammal, it is selected for hybridoma production. The spleen is removed and a single cell suspension is prepared as described by Harlow and Lane (1988). Cell fusions are performed essentially as described by Kohler and Milstein (1975). Briefly, P3.65.3 myeloma cells (American Type Culture Collection, Manassas, Va.) are fused with immune spleen cells using polyethylene glycol as described by Harlow and Lane (1988). Cells are plated at a density of 2×10⁵ cells/well in 96 well tissue culture plates. Individual wells are examined for growth and the supernatants of wells with growth are tested for the presence of subject biomarker specific antibodies by ELISA or RIA using wild type or mutant target protein. Cells in positive wells are expanded and subcloned to establish and confirm monoclonality. Clones with the desired specificities are expanded and grown as ascites in mice or in a hollow fiber system to produce sufficient quantities of antibody for characterization and assay development.

### Sandwich Assay for the Biomarker

Sandwich assays for the detection of a biomolecule comprising a biomarker M1, M2, M3, M4, M5, or M6 can be used as a diagnostic tool for the diagnosis of a subject as being healthy, having a non-malignant disease of the large intestine, having a precancerous lesion of the large intestine, having a localized colorectal cancer, or a metastasised colorectal cancer, or having an acute or a chronic inflammation of colorectal tissue. Sandwich assays consist of attaching a monoclonal antibody to a solid surface such as a plate, tube, bead, or particle, wherein an antibody is preferably attached to the well surface of a 96-well microtitre plate. A pre-determined volume of sample (e.g., serum, urine, tissue cytosol) containing the subject biomarker can be added to the solid phase antibody, and the sample can be incubated for a period of time at a pre-determined temperature conducive for the specific binding of the subject markers within the given sample to the solid phase antibody. Following, a sample fluid can be discarded, and the solid phase can be washed with buffer to remove any unbound material. A volume of a second monoclonal antibody (to a different determinant on the subject biomarker) can be added to the solid phase. This antibody can be labelled with a detector molecule or atom (e.g., enzyme, fluorophore, chromophore, or ¹²⁵I) and the solid phase with the second antibody can be incubated for two hrs at room temperature. The second antibody can be decanted, and the solid phase can be washed with buffer to remove unbound material.

The amount of bound label, which is proportional to the amount of subject biomarker present in the sample, can be quantitated.

### Kits of the Invention

Yet another aspect of the invention provides kits using the methods of the invention as described in another section for differential diagnosis of colorectal cancer or non-malignant disease of the large intestine, wherein the kits are used to detect biomolecules comprising a biomarker M1, M2, M3, M4, M5, or M6.

Methods used to detect biomolecules comprising a biomarker M1, M2, M3, M4, M5, or M6 can also be used to determine whether a subject is at risk of developing colorectal cancer or has developed colorectal cancer. Such methods may also be employed in the form of a diagnostic kit comprising a binding molecule specific to a biomolecule comprising a biomarker M1, M2, M3, M4, M5, or M6, solutions, and materials necessary for the detection of a biomolecule of the invention, and instructions to use the kit based on the above-mentioned methods.

For example, kits can be used to detect one or more biomolecules comprising a biomarker M1, M2, M3, M4, M5, or M6. Kits of the invention have many applications. For example, the kits can be used to differentiate if a subject is healthy, has a non-malignant disease of the large intestine, or has colorectal cancer, thus aiding the diagnosis of colorectal cancer and/or non-malignant disease of the large intestine. Moreover, the kits can be used to differentiate if a subject is healthy, has a non-malignant disease of the large intestine, has a precancerous lesion of the large intestine, has a localized colorectal cancer, has a metastasised colorectal cancer, or has an acute or a chronic inflammation of the large intestine.

In one embodiment, a kit comprises instructions on how to use the kit, an adsorbent on a biologically active surface, wherein the adsorbent is suitable for binding one or more biomolecules of the invention, a denaturation solution for the pre-treatment of a sample, a binding solution, and one or more washing solution(s) or instructions for making a denaturation solution, binding solution, or washing solution(s), wherein the combination allows for the detection of a biomolecule using gas phase ion spectrometry. Such kits can be prepared from the materials described in other previously detailed sections (e.g., denaturation buffer, binding buffer, adsorbents, washing solution(s), etc.).

In some embodiments, a kit may comprise a first substrate comprising an adsorbent thereon (e.g., a particle functionalised with an adsorbent) and a second substrate onto which the first substrate can be positioned to form a probe, which is removably insertable into a gas phase ion spectrometer. In other embodiments, a kit may comprise a single substrate, which is in the form of a removably insertable probe with adsorbents on the substrate.

In another embodiment, a kit comprises a binding molecule or panel of binding molecules that specifically binds to a biomolecule comprising a biomarker M1, M2, M3, M4, M5, or M6, a detection reagent, appropriate solutions and instructions on how to use the kit. Such kits can be prepared from the materials described above, and other materials known to those skilled in the art. A binding molecule used within such a kit may include, but is not limited to, nucleic acids, nucleotides, oligonucleotides, polynucleotides, amino acids, peptides, polypeptides, proteins, monoclonal and/or polyclonal antibodies, sugars, carbohydrates, fatty acids, lipids, steroids, hormones, or a combination thereof (e.g. glycoproteins, ribonucleoproteins, lipoproteins), compounds or synthetic molecules). Preferably, a binding molecule used in said kit is a nucleic acid, nucleotide, oligonucleotide, polynucleotide, amino acid, peptide, polypeptide, and protein, monoclonal and/or polyclonal antibody. In another embodiment, a kit comprises a binding molecule or panel of binding molecules that specifically bind to more than one of the biomolecules comprising a biomarker M1, M2, M3, M4, M5, or M6, a detection reagent, appropriate solutions and instructions on how to use the kit. Each binding molecule would be distinguishable from every other binding molecule in a panel of binding molecules, yielding easily interpreted signal for each of the biomolecules detected by the kit. Such kits can be prepared from the materials described above, and other materials known to those skilled in the art. A binding molecule used within such a kit may include, but is not limited to, nucleic acids, nucleotides, oligonucleotides, polynucleotides, amino acids, peptides, polypeptides, proteins, monoclonal and/or polyclonal antibodies, sugars, carbohydrates, fatty acids, lipids, steroids, hormones, or a combination thereof (e.g. glycoproteins, ribonucleoproteins, lipoproteins), compounds or synthetic molecules. Preferably, a binding molecule used in said kit is a nucleic acid, nucleotide, oligonucleotide, polynucleotide, amino acid, peptide, polypeptide, and protein, monoclonal and/or polyclonal antibody.

In an embodiment, a kit may optionally further comprise a standard or control biomolecule so that the biomolecules detected within a biological sample can be compared with said standard to determine if the test amount of a marker detected in a sample is a diagnostic amount consistent with a diagnosis of a non-malignant disease of the large intestine, a precancerous lesion of the large intestine, localized colorectal cancer, metastasised colorectal cancer, acute or a chronic inflammation of the large intestine. Likewise a biological sample can be compared with said standard to determine if the test amount of a marker detected is said sample is a diagnostic amount consistent with a diagnosis as healthy.

### Composition, Formulation, and Administration of Pharmaceutical Compositions.

Differential expression of biomolecules in samples from healthy subjects, subjects having a non-malignant disease of the large intestine, and subjects having colorectal cancer allows for a differential diagnosis of colorectal cancer or a non-malignant disease of the large intestine within a given subject. Accordingly, biomolecules discovered and characterized herein can be isolated and further characterized using standard laboratory techniques, and used to determine novel treatments for colorectal cancer and non-malignant disease of the large intestine. Knowledge of the association of these biomolecules with colorectal cancer and non-malignant disease of the large intestine can be used, for example, to treat patients with the biomolecule, an antibody specific to the biomolecule, or an antagonist of the biomolecule. In order to treat colorectal cancer, the biomolecules can be prepared in specific pharmaceutical compositions and or formulations that allow for the most efficient and effective delivery of the therapy.

Pharmaceutical compositions of the present invention may be manufactured in a manner that is itself known, e.g., by means of conventional mixing, dissolving, granulating, dragee-making, levigating, emulsifying, encapsulating, entrapping or lyophilizing processes.

Pharmaceutical compositions for use in accordance with the present invention thus may be formulated in conventional manner using one or more physiologically acceptable carriers comprising excipients and auxiliaries, which facilitate processing of the active compounds into preparations, which can be used pharmaceutically. Proper formulation is dependent upon the route of administration chosen.

For injection, agents of the invention may be formulated in aqueous solutions, preferably in physiologically compatible buffers such as Hanks' solution, Ringer's solution, or physiological saline buffer. For transmucosal administration, penetrants appropriate to the barrier to be permeated are used in the formulation. Such penetrants are generally known in the art.

For oral administration, compounds can be formulated readily by combining active compounds with pharmaceutically acceptable carriers known in the art. Such carriers enable compounds of the invention to be formulated as tablets, pills, dragees, capsules, liquids, gels, syrups, slurries, suspensions and the like, for oral ingestion by a patient to be treated. Pharmaceutical preparations for oral use can be obtained by solid excipient, optionally grinding a resulting mixture, and processing the mixture of granules, after adding suitable auxiliaries, if desired, to obtain tablets or dragee cores. Suitable excipients are, in particular, fillers such as sugars, including lactose, sucrose, mannitol, or sorbitol, or cellulose preparations such as, maize starch, wheat starch, rice starch, potato starch, gelatin, gum tragacanth, methyl cellulose, hydroxypropylmethyl-cellulose, sodium carboxymethylcellulose, and/or polyvinylpyrrolidone. If desired, disintegrating agents may be added, such as the cross-linked polyvinylpyrrolidone, agar, or alginic acid or a salt thereof such as sodium alginate.

Dragee cores are provided with suitable coatings. For this purpose, concentrated sugar solutions may be used, which may optionally contain gum arabic, talc, polyvinyl pyrrolidone, carbopol gel, polyethylene glycol, and/or titanium dioxide, lacquer solutions, and suitable organic solvents or solvent mixtures. Dyestuffs or pigments may be added to the tablets or dragee coatings for identification or to characterize different combinations of active compound doses.

Pharmaceutical preparations which can be used orally include push-fit capsules made of gelatin, as well as soft, sealed capsules made of gelatin and a plasticizer, such as glycerol or sorbitol. Push-fit capsules can contain active ingredients in admixture with filler such as lactose, binders such as starches, and/or lubricants such as talc or magnesium stearate and, optionally, stabilizers. In soft capsules, the active compounds may be dissolved or suspended in suitable liquids, such as fatty oils, liquid paraffin, or liquid polyethylene glycols. In addition, stabilizers may be added. All formulations for oral administration should be in dosages suitable for such administration.

For buccal administration, compositions may take the form of tablets or lozenges formulated in a conventional manner.

For administration by inhalation, compounds can be conveniently delivered in the form of an aerosol spray presentation from pressurized packs or a nebulizer, with the use of a suitable propellant, e.g., dichlorodifluoromethane, trichlorofluoromethane, dichlorotetrafluoroethane, carbon dioxide or other suitable gas. In the case of a pressurized aerosol the dosage unit may be determined by providing a valve to deliver a metered amount. Capsules and cartridges (e.g. gelatin) for use in an inhaler or insufflator may be formulated containing a powder mix of the compound and a suitable powder base such as lactose or starch.

Compounds may be formulated for parenteral administration by injection, e.g., by bolus injection or continuous infusion. Formulations for injection may be presented in unit dosage form, e.g., in ampoules or in multidose containers, with an added preservative. Compositions may take such forms as suspensions, solutions or emulsions in oily or aqueous vehicles, and may contain formulatory agents such as suspending, stabilizing and/or dispersing agents.

Pharmaceutical formulations for parenteral administration include aqueous solutions of the active compounds in water-soluble form. Additionally, suspensions of active compounds may be prepared as appropriate oily injection suspensions. Suitable lipophilic solvents or vehicles include fatty oils such as sesame oil, or synthetic fatty acid esters, such as ethyl oleate or triglycerides, or liposomes. Aqueous injection suspensions may contain substances which increase the viscosity of the suspension, such as sodium carboxymethyl cellulose, sorbitol, or dextran. Optionally, a suspension may also contain suitable stabilizers or agents which increase the solubility of the compounds to allow for the preparation of highly concentrated solutions.

In an embodiment, an active ingredient may be in powder form for constitution with a suitable vehicle, e.g., sterile pyrogen-free water, before use.

Compounds may also be formulated in rectal compositions such as suppositories or retention enemas, e.g., containing conventional suppository bases such as cocoa butter or other glycerides.

In addition to the formulations described previously, compounds may also be formulated as a depot preparation. Such long acting formulations may be administered by implantation (for example subcutaneously or intramuscularly) or by intramuscular injection. Thus, for example, compounds may be formulated with suitable polymeric or hydrophobic materials (for example as an emulsion in an acceptable oil) or ion exchange resins, or as sparingly soluble derivatives, for example, as a sparingly soluble salt.

A pharmaceutical carrier for the hydrophobic compounds of the invention is a co-solvent system comprising benzyl alcohol, a nonpolar surfactant, a water-miscible organic polymer, and an aqueous phase. Naturally, the proportions of a co-solvent system may be varied considerably without destroying its solubility and toxicity characteristics. Furthermore, the identity of the co-solvent components may be varied.

In an embodiment, other delivery systems for hydrophobic pharmaceutical compounds may be employed. Liposomes and emulsions are well known examples of delivery vehicles or carriers for hydrophobic drugs. Certain organic solvents such as dimethylsulfoxide also may be employed, although usually at the cost of greater toxicity. Additionally, compounds may be delivered using a sustained-release system, such as semipermeable matrices of solid hydrophobic polymers containing therapeutic agent. Various sustained-release materials have been established and are well known. Sustained-release capsules may, depending on their chemical nature, release compounds for a few weeks up to over 100 days. Depending on the chemical nature and the biological stability of therapeutic reagent, additional strategies for protein stabilization may be employed.

Pharmaceutical compositions also may comprise suitable solid or gel phase carriers or excipients. Examples of such carriers or excipients include, but are not limited to, calcium carbonate, calcium phosphate, various sugars, starches, cellulose derivatives, gelatin, and polymers such as polyethylene glycols.

Compounds may be provided as salts with pharmaceutically compatible counter ions. Pharmaceutically compatible salts may be formed with many acids, including but, not limited to, hydrochloric, sulfuric, acetic, lactic, tartaric, malic, succinic, etc. Salts tend to be more soluble in aqueous or other protonic solvents than are the corresponding free base forms.

Suitable routes of administration may, for example, include oral, rectal, transmucosal, transdermal, or intestinal administration; or parenteral delivery, including intramuscular, subcutaneous, intramedullary injections, as well as intrathecal, direct intraventricular, intravenous, intraperitoneal, intranasal, or intraocular injections.

Alternately, one may administer a compound in a local rather than systemic manner, for example, via injection of a compound directly into an affected area, often in a depot or sustained release formulation.

Furthermore, one may administer a drug in a targeted drug delivery system, for example, in a liposome coated with an antibody specific for affected cells. Liposomes can be targeted to and taken up selectively by the cells.

Pharmaceutical compositions generally are administered in an amount effective for treatment or prophylaxis of a specific indication or indications. It is appreciated that optimum dosage will be determined by standard methods for each treatment modality and indication, taking into account the indication, its severity, route of administration, complicating conditions and the like. In therapy or as a prophylactic, the active agent may be administered to an individual as an injectable composition, for example, as a sterile aqueous dispersion, preferably isotonic. A “therapeutically effective” dose further refers to that amount of the compound sufficient to result in amelioration of symptoms associated with such disorders. Techniques for formulation and administration of the compounds of the instant application may be found in ‘Remington's Pharmaceutical Sciences,’ Mack Publishing Co., Easton, Pa., latest edition. For administration to mammals, and particularly humans, it is expected that a daily dosage level of an active agent will be from 0.001 mg/kg to 10 mg/kg, typically around 0.01 mg/kg. A physician in any event will determine the actual dosage, which will be most suitable for an individual and will vary with the age, weight and response of the particular individual. The above dosages are exemplary of the average case. There can, of course, be individual instances where higher or lower dosage ranges are merited, and such are within the scope of this invention.

Compounds may be particularly useful in animal disorders (veterinarian indications), and particularly mammals.

Embodiments of the invention further provide diagnostic and pharmaceutical packs and kits comprising one or more containers filled with one or more of the ingredients of the aforementioned compositions of the invention. Associated with such container(s) can be a notice in the form prescribed by a governmental agency regulating the manufacture, use or sale of pharmaceuticals or biological products, reflecting approval by the agency of the manufacture, use or sale of the product for human administration.

The present invention is further illustrated by the following examples, which should not be construed as limiting in any way. The contents of all cited references (including literature references, issued patents, published patent applications), as cited throughout this application, are hereby expressly incorporated by reference. The practice of the present invention will employ, unless otherwise indicated, conventional techniques of cell biology, cell culture, molecular biology, transgenic biology, microbiology, recombinant DNA, and immunology, which are known to those skilled in the art. Such techniques are explained fully in the literature.

### EXAMPLES

### Example 1

### Detection of Serum Biomarkers

### Biomarker Discovery

A total of 136 serum samples were collected from patients recruited through the Departments of Gastroenterology and Surgery of the Universities of Erlangen and Magdeburg (both in Germany), and maintained by the European Tumor Sample Institute gGmbH (Hennigsdorf, Germany).

### Sample groups include colorectal cancer (68 patients), benign (45 patients) and controls (23 patients) (Table 1).

TABLE 1
Summary of the distribution of samples for the discovery of
biomarkers for colorectal cancer.

Gender

| | Male | | | Female | | |
|---|---|---|---|---|---|---|
| Site | E | MD | Total | E | MD | Total |
| CRCa | 5 | 31 | 36 | 3 | 29 | 32 |
| Benign | 0 | 18 | 18 | 0 | 27 | 27 |
| Healthy | 0 | 9 | 9 | 0 | 14 | 14 |

CRCa: Colorectal Cancer
MD: Magdeburg.
E: Erlangen.

To determine if there was a significant bias between patient genders or patient ages in different sample groups (CRCa vs. benign disease vs. control; or CRCa vs. non-CRCa), χ² contingency table analyses was performed. Patient age was categorized as either less than 55 years, 56 to 65 years, 66 to 75 years, over 75 years, or not reported. No gender bias was detected for patient diagnosis (P>0.165), but a bias was observed in patient age, with ˜12% of CRCa and ˜38% of non-CRCa patients being under the age of 55 years (Table 2).

TABLE 2
Results of χ² contingency table analysis to assess gender and age bias.

| | Gender Bias | | Age Bias | |
|---|---|---|---|---|
| | CRCa vs. Benign | CRCa vs. | CRCa vs. | CRCa vs. |
| | vs. Control | Non-CRCa | Benign vs. Control | Non-CRCa |
| P | 0.166 | 0.167 | 0.034 | 0.0074 |

CRCa: Colorectal cancer
Non-CRCa: Healthy controls and benign colorectal disease

Serum samples were randomly applied to Q10 ProteinChip array surfaces that consist of cationic quaternary amines groups. Such array surfaces are selective for molecules that have negatively charged surfaces. Pooled serum (quality control) and PBS (negative control) were also applied to each array to control for inter-array bias. All samples were applied in duplicate.

Samples were processed directly on the array surfaces and subsequently assayed using a PCS4000 SELDI-TOF MS over a mass range of 0 to 30,000 m/z and the energy absorbing molecule sinapinic acid (SPA).

The spectra generated for each applied sample were normalized for total ion current using the Normalize Spectra functionality of CiphergenExpress™ version 3.0 over a mass range of 1,500 to 30,000 m/z. The mean and standard deviation for the distribution of normalization factors applied to spectra (excluding those generated from quality assurance spots) were calculated and those spectra with a normalization factor of more than two standard deviations from the mean were discarded.

Peak detection was conducted using the Entity Difference Map functionality of CiphergenExpress™ version 3.0. Those peaks that were estimated in 90% or more of spectra were discarded. Peaks that were retained underwent statistical testing (non-parametric methods, including Mann-Whitney rank sum testing for comparisons of two groups, and Kruskal-Wallis testing for comparisons of more than two groups) in conjunction with false discovery rate analyses, ROC-AUC statistics and attribute evaluation algorithms in the Waikato Environment for Knowledge Analysis (WEKA).

Statistical analysis of the spectra generated indicated 27 potentially useful markers for the diagnosis of colorectal cancer. These markers were able to distinguish patients with benign disease from those with CRCa, control patients from those with CRCa, or non-CRCa patients from those with CRCa.

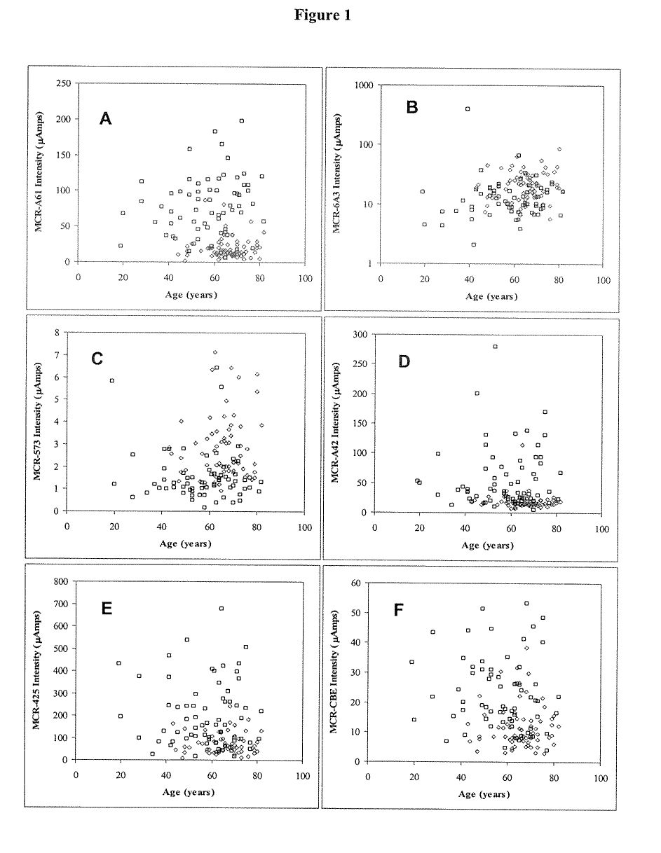

Furthermore, there is an overlap in statistical significance for each of these comparisons for many of these markers (Table 3). Although the markers are unlikely to be the result of gender bias, future studies will require the use of better age-matched controls to ensure that patient age is not a confounding factor. Initial scatter-plot analysis of the six most significant biomarkers did not detect a correlation between signal intensity and patient age (FIG. 1).

TABLE 3
Summary of peaks capable of differentiating serum from healthy controls and/or
benign colorectal disease patients from colorectal cancer patients.

| | Differentiates | | | Maximum | Elevated in . . . | |
|---|---|---|---|---|---|---|
| Marker | Colorectal Cancer from . . . | | | ROC- | | Non- |
| ID | Ctrl | Benign | Ctrl + Benign | AUC | CRCa | CRCa |
| MCR-A61 | 3.31 × 10⁻¹¹ (1%) | 6.04 × 10⁻¹⁴ (1%) | 2.51 × 10⁻¹⁸ (1%) | 0.95 | — | ✓ |
| MCR-A42 | 2.86 × 10⁻⁸ (1%) | 3.56 × 10⁻¹² (1%) | 5.83 × 10⁻¹⁵ (1%) | 0.78 | — | ✓ |
| MCR-6A3 | 8.72 × 10⁻¹¹ (1%) | 8.4 × 10⁻¹⁰ (1%) | 2.15 × 10⁻¹⁴ (1%) | 0.92 | ✓ | — |
| MCR-425 | 1.88 × 10⁻⁶ (1%) | 3.11 × 10⁻⁹ (1%) | 2.55 × 10⁻¹¹ (1%) | 0.83 | — | ✓ |
| MCR-573 | 1.05 × 10⁻⁶ (1%) | 1.81 × 10⁻⁸ (1%) | 7.79 × 10⁻¹¹ (1%) | 0.83 | ✓ | — |
| MCR-CBE | 5.44 × 10⁻⁴ (1%) | 3.22 × 10⁻⁹ (1%) | 1.46 × 10⁻⁹ (1%) | 0.82 | — | ✓ |
| MCR-5F4 | 7.51 × 10⁻⁸ (1%) | 1.37 × 10⁻⁴ (1%) | 7.26 × 10⁻⁸ (1%) | 0.85 | ✓ | — |
| MCR-058 | 8.58 × 10⁻³ (5%) | 1.65 × 10⁻⁷ (1%) | 2.66 × 10⁻⁷ (1%) | 0.77 | — | ✓ |
| MCR-737 | — | — | 1.12 × 10⁻⁵ (1%) | 0.70 | — | ✓ |
| MCR-5B5 | 5.82 × 10⁻⁴ (1%) | 3.60 × 10⁻⁴ (1%) | 1.82 × 10⁻⁵ (1%) | 0.72 | — | ✓ |
| MCR-7E7 | 1.19 × 10⁻³ (5%) | 3.67 × 10⁻⁴ (1%) | 2.81 × 10⁻⁵ (1%) | 0.71 | — | ✓ |
| MCR-6DF | 1.15 × 10⁻³ (1%) | 2.26 × 10⁻³ (5%) | 1.37 × 10⁻⁴ (1%) | 0.71 | — | ✓ |
| MCR-AED | 2.74 × 10⁻⁴ (1%) | — | 6.51 × 10⁻⁴ (1%) | 0.75 | ✓ | — |
| MCR-95C | 2.00 × 10⁻⁴ (1%) | — | 7.00 × 10⁻⁴ (1%) | 0.75 | ✓ | — |
| MCR-85F | 3.50 × 10⁻⁴ (1%) | — | 1.15 × 10⁻³ (1%) | 0.74 | ✓ | — |
| MCR-3AD | 1.67 × 10⁻⁴ (1%) | — | 2.25 × 10⁻³ (1%) | 0.75 | ✓ | — |
| MCR-3DB | 2.38 × 10⁻⁴ (1%) | — | 3.51 × 10⁻³ (1%) | 0.74 | ✓ | — |
| MCR-031 | — | 6.58 × 10⁻³ (5%) | 3.16 × 10⁻³ (5%) | 0.63 | ✓ | — |
| MCR-764 | 0.039 (>10%) | 7.41 × 10⁻⁴ (1%) | 3.43 × 10⁻³ (5%) | 0.69 | — | ✓ |
| MCR-FB1 | — | 1.54 × 10⁻⁴ (1%) | 7.26 × 10⁻³ (5%) | 0.70 | — | ✓ |
| MCR-B25 | — | 0.036 (10%) | 0.016 (10%) | 0.62 | ✓ | — |
| MCR-300 | 0.032 (5%) | — | 0.037 (>10%) | 0.66 | ✓ | — |
| MCR-C9D | — | 0.037 (5%) | 0.045 (>10%) | 0.62 | — | ✓ |
| MCR-0C3 | 9.28 × 10⁻³ (10%) | — | 0.046 (>10%) | 0.68 | — | ✓ |
| MCR-0AF | 0.020 (10%) | — | 0.037 (>10%) | 0.67 | — | ✓ |
| MCR-523 | — | 0.019 (5%) | — | 0.60 | — | ✓ |
| MCR-845 | 0.011 (10%) | — | — | 0.66 | — | ✓ |

P values are given where P < 0.05.
Values in parentheses indicate levels of false discovery rate (FDR) significance.
Of those markers with FDR ≦1%, we expect to observe less than one that is falsely significant.

TABLE 4
Relationship of m/z ratios and Corresponding
Biomarker Nomenclature.

| | Correcponding |
|---|---|
| | Biomarker |
| M/Z | Name |
| 1540.37 | MCR-737 |
| 1614.89 | MCR-5F4 |
| 1992.11 | MCR-3AD |
| 2008.69 | MCR-AED |
| 2028.53 | MCR-3DB |
| 2258.28 | MCR-95C |
| 2468.30 | MCR-6A3 |
| 2601.50 | MCR-FB1 |
| 3001.01 | MCR-85F |
| 3367.30 | MCR-058 |
| 3440.70 | MCR-CBE |
| 3930.32 | MCR-425 |
| 4148.70 | MCR-C9D |
| 4620.43 | MCR-300 |
| 4783.54 | MCR-523 |
| 4956.82 | MCR-A42 |
| 5469.00 | MCR-A61 |
| 5626.58 | MCR-764 |
| 9332.46 | MCR-031 |
| 9403.25 | MCR-0C3 |
| 9549.46 | MCR-B25 |
| 12583.21 | MCR-573 |
| 13950.47 | MCR-0AF |
| 15104.64 | MCR-5B5 |
| 15304.31 | MCR-7E7 |
| 15833.06 | MCR-6DF |
| 17846.29 | MCR-845 |

### Diagnostic Test Development.

WEKA was used to apply several different rule and tree-based algorithms (Table 5) to the 27 biomarkers discovered, with a subset of five of these biomarkers (MCR-A61, MCR-A42, MCR-425, MCR-573 and MCR-764 (see Table 3) consistently being selected by the software for use in the classification models. Application of one of these algorithms (OneR) to bagging meta-analysis of the two individually most significant markers (MCR-A42 and MCR-A61) using a majority vote of 10 different classifiers to generate a diagnostic decision improved test sensitivity and specificity, though not beyond the 95% confidence interval of the mean for either statistic (Table 6). A minimum of ten-fold cross-validation was used to promote test robustness.

TABLE 5
Evaluation of the sensitivity and specificity for diagnostic tests based
on multiple serum biomarkers of colorectal cancer. Markers
MCR-A61, MCR-A42, M1, MCR-573 and M3 were used with 10-fold
cross validation to generate a series of classification models.

| | Diagnosis | | | | | |
|---|---|---|---|---|---|---|
| Algorithm | Category . . . | | | | Calculated . . . | |
| Used | TP | TN | FP | FN | Sensitivity (%) | Specificity (%) |
| J48 Tree | 59 | 57 | 11 | 11 | 84.3 ± 8.5 | 83.8 ± 8.8 |
| JRip | 59 | 54 | 14 | 11 | 84.3 ± 8.5 | 79.4 ± 9.6 |
| NBTree | 56 | 55 | 13 | 14 | 80.0 ± 9.4 | 80.9 ± 9.4 |
| OneR | 57 | 57 | 11 | 13 | 81.4 ± 9.1 | 83.8 ± 8.8 |
| PART | 61 | 53 | 15 | 9 | 87.1 ± 7.8 | 77.9 ± 9.9 |
| RiDoR | 59 | 53 | 15 | 11 | 84.3 ± 8.5 | 77.9 ± 9.9 |

TP: true positive.
TN: true negative.
FP: false positive.
FN: false negative.

TABLE 6
Effects of bagging meta-analysis on sensitivity and
specificity of two markers using the OneR algorithm.

| Marker(s) | Sensitivity | Specificity | Correct |
|---|---|---|---|
| Used | (%) | (%) | (%) |
| MCR-A42 alone | 88.6 ± 7.5 | 76.5 ± 10.1 | 82.6 ± 6.3 |
| MCR-A61 alone | 84.3 ± 8.5 | 85.3 ± 8.4 | 84.8 ± 6.0 |
| MCR-A42 and MCR-A61 | 81.4 ± 9.1 | 82.4 ± 9.1 | 81.9 ± 6.4 |

### Example 2

### Validation of Serum Biomarkers for Colorectal Cancer Diagnosis

A total of 371 serum samples were collected. Of the 371 samples, 165 serum samples were obtained from ETSI (European Tumour Sample Institute, Hennigsdorf, Germany), and 206 were obtained from FCCC (Fox Chase Cancer Centre, Philadelphia, Pa.). Samples obtained from both sites included three different groups of subjects. Group A sera were drawn from 146 colorectal cancer patients. Diagnosis was made based on endoscopy, ultrasonic testing, and/or other means of colorectal cancer detection, and was confirmed by post-surgical histological evaluation.

Group B consisted of sera drawn from 104 patients with non-malignant (“benign”) disease symptoms of the large intestine (for example, benign polyps, adenoma, inflammation, diverticulitis). Sera were collected following colorectal endoscopy to confirm the absence of colorectal cancer.

Group C sera were drawn from 121 healthy patients who were not suffering from a disease at the time of sample collection.

All serum samples were stored in single-use aliquots at −80° C.

Serum samples (100 μL aliquots) stored at −80° C. were thawed at room temperature and immediately placed on ice. 15 μL of each serum sample was mixed with 60 μL of Lysis Solution E (7M Urea, 2M thiourea, 4% CHAPS, 1% DTT and 2% ampholine) in a set of 1.5 mL microcentrifuge tubes and samples were incubated on ice for 15 min. After incubation, 675 μL of Binding Buffer SAX2 (0.1M Tris HCl pH8.5) was added to each of the samples. All samples were then placed on ice.

To detect the presence or absence of biomarkers in patient serum samples, ProteinChip array analysis was performed using a strong anion exchange protein chip array (Q10 ProteinChip® Arrays). Q10 ProteinChips® were pre-incubated with 200 μl of Binding Buffer SAX2 per spot at room temperature for 10 minutes with vigorous shaking. The buffer was removed and serum sample applied to randomly selected duplicate spots. In addition, each ProteinChip® array was spotted on one spot with a positive control (pooled serum sample) and one spot with a negative control (Binding Buffer SAX2) for quality assurance purposes. Samples were then incubated at room temperature for 2 hrs with vigorous shaking. After incubation, samples were removed from each spot, and the arrays were blotted dry on paper towels. Following this, each spot was washed two times, with each wash consisting of the application of 200 μL of Binding Buffer SAX2 for 15 minutes at room temperature on a shaker. Spots were then allowed to air dry for 15 minutes at room temperature, after which two applications of 0.5 μL of sinapinic acid (125 μL of acetonitrile and 125 μL of 1% trifluoroacetic acid combined with one vial of sinapinic acid powder (Ciphergen, Cat # C300-0002, Lot # SPA051128)) were applied to each spot, allowing spots to air dry for 10 minutes in between applications of sinapinic acid.

Prior to reading the arrays, the Ciphergen PCS-4000 SELDI-TOF mass spectrometer was externally calibrated for mass accuracy using five calibrants: porcine dynorphin A209-225 (2147.5 g/mole); human β-endorphin61-91 (3465.0 g/mole); bovine insulin (5733.58 g/mole); bovine cytochrome C (12230.92 g/mol) and equine cardiac myoglobin (16951.51 g/mol). Derived coefficients (mean ±standard deviation) for the calibration were:

t₀=−6.0302×10⁻⁸±2.929479×10⁻⁸

a=3.288×10⁸±0.004533×10⁻⁸

b=−5.032×10⁻⁴±1.698×10⁻⁴

u=25000±0

Time of flight spectra were generated by laser shots collected in the positive mode using a laser intensity of 2000 or 3000 nJ, sampling rate of 400, matrix attenuation set to 500 Da, a mass range of 0 to 30,000 Da and a focus mass of 10,000 Da. 530 individual laser shots were taken of each spot and averaged to give the final spectrum.

Spectra were normalized for total ion current using the Normalize Spectra functionality of CiphergenExpress® version 3.0 over a mass range of 1,500 to 30,000 m/z. The mean and standard deviation for the distribution of normalization factors applied to spectra (excluding those generated from quality assurance spots) were calculated and those spectra with a normalization factor more than two standard deviations from the mean were discarded (Table 7).

TABLE 7
Summary of spectra excluded from data analysis because
of excessive normalization factor in the 1500-30000 mz range.

| | | Sample . . . | | | Normalization |
|---|---|---|---|---|---|
| ProteinChip# | Spot ID | Name | Type | Site | Factor |
| 1230184152 | C | 03149FDA | Ctrl | ETSI | 9.5831 |
| 1230184071 | C | 103EF698 | Benign | ETSI | 7.6370 |
| 1230184150 | C | 2EB1DC0D | Benign | ETSI | 5.2709 |
| 1230188520 | E | 59ECA771 | CRCa | FCCC | 6.9923 |
| 1230184260 | B | 5FF5DF90 | CRCa | ETSI | 5.2723 |
| 1230188523 | H | 6166B18D | CRCa | FCCC | 7.0021 |
| 1230188522 | B | 73897A5E | CRCa | FCCC | 5.1761 |
| 1230188525 | C | 77F9571B | CRCa | FCCC | 5.8439 |
| 1230184150 | B | 7CBB8768 | CRCa | ETSI | 9.1306 |
| 1230184145 | E | 84748FD8 | CRCa | ETSI | 6.8175 |
| 1230184203 | F | A4C0BC67 | CRCa | ETSI | 7.6168 |
| 1230188525 | A | A5F1C75D | Benign | FCCC | 5.9424 |
| 1230196430 | E | A759734B | CRCa | ETSI | 46.1345 |
| 1230196490 | E | A759734B | CRCa | ETSI | 27.3781 |
| 1230184149 | E | B348789D | CRCa | ETSI | 9.0500 |
| 1230184151 | F | C79A6586 | Benign | ETSI | 7.6707 |
| 1230184202 | H | CAE5055D | Benign | ETSI | 11.3249 |
| 1230188521 | E | D4436646 | Benign | FCCC | 14.6780 |
| 1230184151 | C | F9EE5F41 | Benign | ETSI | 6.0210 |
| 1230184200 | G | F9FBF437 | CRCa | ETSI | 10.0477 |

Peak detection was conducted using the Entity Difference Map functionality of CiphergenExpress® version 3.0 using the following parameters: First Pass S/N=3.0, First Pass Valley Depth=3.0, Second Pass S/N=2.0, Second Pass Valley Depth=2.0, Minimum Peak Threshold=0%, Cluster Mass Window=0.3%, Minimum m/z: 1,500, Maximum m/z: 30,000. Those peaks that were estimated in 90% or more of spectra were discarded.

Peaks that were independently detected (that is, not estimated) in at least 10% of all spectra underwent statistical testing by Mann-Whitney rank sum testing using the P-value wizard functionality of CiphergenExpress® version 3.0, based on samples that had been subdivided according to date of assay and site of sample collection. The statistical analysis revealed that several potentially useful markers could be used to differentiate benign disease vs. colorectal cancer, healthy control vs. colorectal cancer, and non-cancer (benign disease and healthy control) vs. colorectal cancer: peaks 3931.42 m/z, 5062.85 m/z, 5615.04 m/z, 11430.65 m/z, 11541.25 m/z and 11678.05 m/z having the designations M1, M2, M3, M4, M5 and M6, respectively. (Table 8) Additional nomenclature of the detected biomarkers is provided in Table 8.

TABLE 8
Validated Biomarker Designation based on m/z

| | | Biomarker |
|---|---|---|
| M/Z | Designation | Name |
| 3932.42^{@} | MCR-425 | M1 |
| 5062.85 | MCR-72C | M2 |
| 5615.04^{@} | MCR-764 | M3 |
| 11430.65 | MCR-2E4 | M4 |
| 11541.25 | MCR-D86 | M5 |
| 11678.05 | MCR-5EF | M6 |

Comparisons were done for benign disease versus colorectal cancer, healthy control versus colorectal cancer, and non-cancer (benign disease and healthy control) versus colorectal cancer for each sample subset. Through these comparisons, a total of six peak comparisons were found to have P<0.05 for at least one comparison across all sample subsets. These comparisons also had diagnostic ROC-AUC, wherein ROC-AUC is significantly greater than 0.50 (Table 9).

TABLE 9
Summary of the observed receiver operator characteristic curve
areas (ROC-AUC) for colorectal cancer biomarkers that were
validated during both sets of biomarker discovery and validation.

| | | ROC-AUC for the comparison of . . . | | |
|---|---|---|---|---|
| | Mass | | | CRCa vs. |
| Biomarker | (g/mol) | CRCa vs. Benign | CRCa vs. Ctrl | Non-CRCa |
| M1 | 3932.42 | 0.71 ± 0.14 | — | 0.62 ± 0.01 |
| M2 | 5062.85 | 0.66 ± 0.04 | 0.66 ± 0.03 | 0.65 ± 0.04 |
| M3 | 5615.04 | — | 0.67 ± 0.05 | — |
| M4 | 11430.65 | 0.64 ± 0.03 | — | 0.65 ± 0.02 |
| M5 | 11541.25 | 0.65 ± 0.04 | 0.65 ± 0.03 | 0.65 ± 0.02 |
| M6 | 11678.05 | — | 0.66 ± 0.02 | 0.63 ± 0.04 |

Only those markers that were discovered and validated in both replicate experiments and had consistent relative expression levels between cancer and non-cancer samples in all four data sets are listed. Values are given as the mean ROC-AUC±one standard deviation. CRCa: Colorectal cancer. Ctrl: Healthy controls. Benign: Benign colorectal disease. Non-CRCa: Healthy controls and benign colorectal disease.

The peaks found to be statistically significant for at least one comparison in all sample subsets assayed were then combined in a pair-wise manner to establish their diagnostic capability in a panel compared to their use in isolation. Briefly, peak intensities for peaks M1, M2 and M3 from each sample were ordered in ascending order, and the sensitivity and specificity calculated for each sample. This was done for each sample X by assuming that all samples with an equal or lesser intensity than that of sample X would be diagnosed as having CRC, while those with a greater intensity than sample X would be diagnosed as not having CRC. The number of true positive, false positive, true negative and false negative diagnoses made were then used to calculate sensitivity and specificity values using the formulae: [sensitivity=100*(# True Positives)/(# True Positives+# False Negatives)] and [sensitivity=100*(# True Negatives)/(# True Negatives+# False Positives)]. Likewise, the rate of correct diagnosis was calculated as [% correct=100*(# True Positives+# True Negatives)/(# True Positives+# True Negatives+# False Positives+# False Negatives)]. Intensity values for peaks M1, M2 and M3 used as diagnostic cut-offs for test comparison purposes were selected to give the maximum specificity when sensitivity was set to >=90%. Those samples diagnosed as being from patients with CRC based on these cut-offs were then re-analysed using peak 11678 using the same procedure outlined above for peaks M1, M2 and M3, except that all samples with an equal or lesser intensity than that of sample X would be diagnosed as not having CRC, while those with a greater intensity than sample X would be diagnosed as having CRC. Again, intensity values for peak M6 used as diagnostic cut-offs for test comparison purposes were selected to give the maximum specificity when sensitivity was set to >=90% for the subset of the population tested. The combined cut-offs of peaks M1 and M6, or of peaks M2 and M6, or of peaks M3 and M6, were then used to establish sensitivities, specificities and correct diagnosis rates across the entire population of samples. In the case of the tests derived from peaks M2 and M6, cut-off values were evaluated by calculating their sensitivities, specificities and correct diagnosis rates when applied to an independent set of samples not used to generate the cut-off values. It was noted that peak M6 appears to have correlated intensity levels with peaks M4 and M5.

| | | |
|---|---|---|
| A) | Test With M2 Alone: | Into < 33.416 THEN Cancer ELSE |
| | | Control |
| | Test With M6 Alone: | Int < 1.0421 THEN Control ELSE Cancer |
| | Test With M2 ANP M6 | M2 > 33.42 Then Ctrl ELSE IF |
| | | M6 < 0.98 Then Ctrl ELSE PCa. |

Effectiveness of tests in the training set of samples:

| | | |
|---|---|---|
| M2 alone | Sensitivity | 90.78947368 |
| | Specificity | 20.3125 |
| | % correct | 46.56862745 |
| M6 alone | Sensitivity | 90.78947368 |
| | Specificity | 34.375 |
| | % correct | 55.39215686 |
| M2 + M6 | Sensitivity | 86.84210526 |
| | Specificity | 42.96875 |
| | % correct | 59.31372549 |

Effectiveness of tests in the test set of samples:

| | | |
|---|---|---|
| M2 alone | Sensitivity | 98.55072464 |
| | Specificity | 9.85915493 |
| | % correct | 53.57142857 |
| M6 alone | Sensitivity | 100 |
| | Spec | 7.042253521 |
| | % correct | 52.85714286 |
| M2 + M6 | Sensitivity | 98.55072464 |
| | Specificity | 14.08450704 |
| | % correct | 55.71428571 |

| | | |
|---|---|---|
| B) | Test With M1 Alone: | Int > 366.434 THEN Cancer ELSE |
| | | Control |
| | Test With M6 Alone: | Int < 1.042 THEN Control ELSE Cancer |
| | Test With M1 AND M6: | M1 > 366.434 Then Control ELSE IF |
| | | M6 < 1.042 Then Control ELSE PCa |

| | | |
|---|---|---|
| M1 alone: | Sensitivity | 89.47368421 |
| | Specificity | 23.4375 |
| | % correct | 48.03921569 |
| M1 + M6: | Sensitivity | 81.57894737 |
| | Specificity | 51.5625 |
| | % correct | 62.74509804 |

| | | |
|---|---|---|
| C) | Test With M3 Alone: | Int > 72.01 THEN Control ELSE Cancer |
| | Test With M6 Alone: | Int < 1.063 THEN Control ELSE Cancer |
| | Test With M3 AND M6: | M3 > 72.01 Then Control ELSE IF |
| | | M6 < 1.063 Then Control ELSE PCa |

| | | |
|---|---|---|
| M3 alone: | Sensitivity | 93.42105263 |
| | Specificity | 14.0625 |
| | % correct | 43.62745098 |
| M3 + M6: | Sensitivity | 84.21052632 |
| | Specificity | 42.1875 |
| | % correct | 57.84313725 |

### Summary

Statistical analysis of the spectra generated for this work indicated that six biomarkers capable of discriminating CRCa from non-CRCa patients in two sets of samples obtained from different institutions, and which were assayed on at least two different occasions (Table 9). The peaks listed were statistically significant (P<0.05) in at least one of the three comparisons for each of four sets of samples assayed (ETSI biomarker discovery and validation confirmation, FCCC biomarker validation and validation confirmation). Values given are for the mean area under the receiver operator characteristic curve for the four sets of samples assayed. Error represents one standard deviation around the mean.

These six markers fall in two general groups, those with amplified expression in CRCa compared to non-CRCa patients, and those with reduced expression in CRCa compared to non-CRCa patients (Table 10). Differences between CRCa and non-CRCa patients were typically greater when looking at samples obtained from ETSI compared to samples obtained to FCCC.

TABLE 10
Summary of expression patterns for peaks capable of
differentiating serum from healthy controls and/or benign
colorectal disease patients from colorectal cancer patients.

| | ETSI | | | | FCCC | | | |
|---|---|---|---|---|---|---|---|---|
| Marker | Mean | | Median | | Mean | | Median | |
| ID | CRCa | Non-CRCa | CRCa | Non-CRCa | CRCa | Non-CRCa | CRCa | Non-CRCa |
| M1 | 53.5 | 181.7 | 41 | 128.9 | 211.8 | 243.8 | 171 | 187 |
| M2 | 15.1 | 21.2 | 13.6 | 20.1 | 20 | 23.9 | 19.5 | 23.6 |
| M3 | 28.9 | 50.4 | 26.2 | 45.6 | 37.5 | 43.6 | 37.3 | 41.5 |
| M3 | 6.7 | 4.3 | 2.5 | 1.9 | 3.9 | 3 | 1.6 | 1.4 |
| M5 | 5.2 | 2.9 | 1.4 | 0.9 | 4 | 2.2 | 0.8 | 0.5 |
| M6 | 13.3 | 7.2 | 3.5 | 2.3 | 6.4 | 5.8 | 2.1 | 1.4 |

CRCa: Colorectal cancer.
Ctrl: Healthy controls.
Non-CRCa: Healthy controls and benign colorectal disease.
Units for mean and median peak intensities are μAmps.
Bold face indicates the sample group which has the greatest expression for a particular marker.

### Diagnostic Test Development

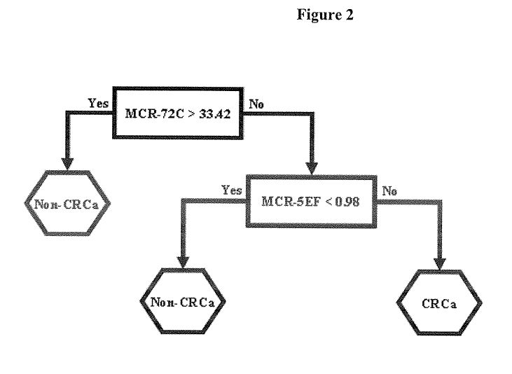

Using spectra generated during biomarker validation confirmation from samples obtained from FCCC as a training dataset, derivation of a diagnostic algorithm was conducted using one biomarker from each of the two general groups outlined in Table 9. These biomarkers were applied in a simple tree-type decision model to give a diagnosis of colorectal cancer or non-colorectal cancer (FIG. 2).

Performance was assessed on samples obtained from ETSI and assayed during biomarker validation confirmation (Table 11). Markers M2 and M6 were used to generate a classification model using samples obtained from FCCC as a training data set. This model was then applied to the samples obtained from ETSI as a naive test data set.

TABLE 11
Evaluation of the sensitivity and specificity for diagnostic tests
based on multiple serum biomarkers of colorectal cancer.

| | FCCC Samples | | | ETSI Samples | | |
|---|---|---|---|---|---|---|
| | M2 | M6 | Combined | M2 | M6 | Combined |
| Sensitivity | 90.8 | 90.8 | 86.8 | 98.6 | 100 | 98.6 |
| Specificity | 20.3 | 34.3 | 43 | 9.9 | 7 | 14.1 |

Markers M2, M6 to generate a classification model using samples obtained from FCCC as a training data set. This model was then applied to the samples obtained from ETSI as a naive test data set. Values given for sensitivity and specificity are expressed as percentages.

Another approach used to define classification models based on these data was the creation of logistic regression models applying all of the markers listed in Table 9. An advantage of this approach is that it is conducive to ROC-AUC measurement in a way that tree or rule based classification models are not. Several logistic regression models were created using the cost sensitive classifier functionality of WEKA, with 10-fold cross validation being done on one set of samples (either those from patients recruited through FCCC or those from patients recruited through ETSI).

Two of these models (one developed on FCCC samples, one developed on ETSI samples) were subsequently evaluated on the remainder of the samples available, giving one model developed on FCCC samples and tested on ETSI samples, the other developed on ETSI samples and tested on FCCC samples. Performance of these models is given in Table 12. Performance is given for both the FCCC and ETSI sample sets when the FCCC samples are used for training the logistic classification model or the ETSI samples are used for training the logistic classification model. Empiric ROC-AUC was determined using the program JROCFit (www.radjhmi.edu/jeng/javarad/roc/JROCFITi.html).

TABLE 12
Performance of logistic regression models for CRCa diagnosis.

| | | |
|---|---|---|
| Training Samples Used | FCCC | ETSI |

| Sample Set | FCCC | ETSI | FCCC | ETSI |
|---|---|---|---|---|
| Empiric ROC-AUC | 0.671 | 0.798 | 0.641 | 0.86 |

Training Samples Used: The sample set used to develop the logistic regression model with.

### Example 5

### Purification and Identification of Biomarker M1

Biomarker M1 was purified from healthy blood donor serum. 4800 μl serum was mixed with 4800 μl denaturing buffer (7M urea, 2M thiourea, 1% DTT and 0.02% Triton®-X 100), incubated on ice for 10 min and diluted 1:10 in SAX binding buffer (0.1M Tris-HCl, 0.02% Triton®-X 100, pH8.5) to a final volume of 96 mL.

The chromatographic steps were performed (i) at 4° C. by using the Äkta system (Amersham Biosciences, Uppsala, Sweden) or (ii) at 10° C. by using the Vision Workstation (Applied Biosystems, Foster City, Calif., USA). The anion-exchange chromatography of the diluted serum was performed on a HiTrap Q FF (5 ml, Amersham Biosciences) column with 0.1M Tris-HCl (pH 8.5), 0.02% Triton®-X 100, 0.25 M urea, 0.08% DTT and a linear NaCl gradient from 0 to 2 M over 50 ml for elution of the proteins (two runs in parallel).

All fractions were analyzed by MALDI-TOF. 2011 of a fraction was concentrated and desalted using ZipTip_{μ-C18} (Millipore, Billerica, Mass., USA) according to the user manual. ZipTips were washed with 50% acetonitrile, 0.1% TFA and equilibrated with 0.1% TFA. 0.1% TFA was used as washing solution. Elution was performed with 1.5 μl matrix solution (20 mg/ml sinapinic acid in 50% acetonitrile, 0.3% TFA) directly onto the MALDI target. Measurements were performed on a Voyager-DE STR MALDI-TOF (Applied Biosystems) mass spectrometer as described above.

Biomarker M1 eluted at about 0.4 M NaCl. The most intense fractions (according to MALDI measurement) were combined and precipitated (TCA-DOC precipitation), by adding 1/100 vol. of 2% DOC (deoxycholate) to one volume of protein solution, vortexed and incubated for 30 min at 4° C. Subsequently 1/10 vol. of TCA was added, the sample was vortexed and incubated on ice for at least 15 min. Afterwards centrifugation was performed at 15000 g for 10 min at 4° C. The pellet was dried by inverting the tube. Pellet was washed twice with one volume cold acetone (vortex and re-pellet sample 5 min at full speed between washes). The sample was dried in a speed-vac and resuspended in a minimal volume of sample buffer (0.1 M Tris-HCl, pH8.5, 0.08% DTT, 2M NaCl).

The pooled sample was chromatographed on a HiTrap Phenyl HP (Amersham Biosciences) column (bed volume, 1 ml) with 0.1M Tris-HCl (pH 8.5), 0.08% DTT, 2 M NaCl and a gradient to 0 M NaCl over 10 ml.

All fractions were analyzed by MALDI-TOF as described above. Biomarker M1 was detected in the flow through fractions. The most intense fractions (MALDI measurement) were combined and precipitated (TCA-DOC precipitation) as described above.

The pooled peak sample was dissolved in running buffer and chromatography was performed on a Mono Q HR 5/5 column (Amersham Biosciences) with 0.1 M Tris-HCl (pH 8.5), 0.25 M urea, 0.08% DTT and a linear NaCl gradient from 0 to 1 M over 20 ml for elution of the proteins. All fractions were analyzed by MALDI-TOF as described above. Biomarker M1 eluted at about 0.4 M NaCl.

The fraction (1 ml) containing biomarker M1 was applied to a reversed phase column. RP-HPLC was performed on a Vision Workstation (Applied Biosystems) using a 100×2 mm C8 Column (Prontosil 300-5-C8 SH 5 μm, Bischoff, Leonberg, Germany). Eluent A was 0.1% TFA in 95% H₂O, 5% acetonitrile; buffer B was 0.085% TFA in 95% acetonitrile, 5% H₂O. The gradient applied was linear from 0% B to 20% B in 3 min; 20% B to 45% B in 30 min and 45% B to 100% B in 3 min. All fractions of reversed-phase chromatography were dried in a vacuum concentrator and redissolved in 5 μl 50% acetonitrile, 0.1% (TFA). 0.7 μl redissolved sample was mixed with 0.7 μl matrix (20 mg/ml sinapinic acid in 50% acetonitrile, 0.3% TFA) and 1 μl was applied onto the MALDI target. Measurements were performed on a Voyager-DE STR MALDI-TOF (Applied Biosystems) mass spectrometer as described above. Biomarker M1 eluted at about 40% B.

The remaining fraction containing biomarker M1 was diluted with 36 μl 0.1% TFA and then processed with ZipTip_{μ-C18} (Millipore). Elution was performed with 2.5 μl 50% acetonitrile, 0.1% formic acid (FA). The eluate was analyzed by nano-electrospray MS/MS using a Q-TOF Micro (Micromass, Manchester, UK). ESI-MS/MS measurement was performed for m/z [M+5H]⁵⁺=787.36. The molecular mass determined with ESI-MS was [M]=3931.79 Da (+−0.01%) (monoisotopic mass). The spectra were interpreted manually. Detected sequence information was used for database search with the search engine MASCOT (Matrixscience, London, UK). The peptide was identified as fragment of Prothrombin (SwissProt P00734; amino acids 328-362; calculated monoisotopic molecular mass [M]=3931.91 Da).

### Example 6

### Purification and Identification of Peak M3

Biomarker M3 was purified from healthy blood donor serum. 4800 μl serum was mixed with 4800 μl denaturing buffer (7 M urea, 2 M thiourea, 1% DTT and 0.02% Triton®-X 100), incubated on ice for 10 min and diluted 1:10 in SAX binding buffer (0.1M Tris-HCl (pH 8.5) 0.02% Triton®-X 100) to a final of 96 ml.

The chromatographic steps were performed (i) at 4° C. by using the Äkta system (Amersham Biosciences, Uppsala, Sweden) or (ii) at 10° C. by using the Vision Workstation (Applied Biosystems, Foster City, Calif., USA). The anion-exchange chromatography of the diluted serum was performed on a HiTrap Q FF (5 ml, Amersham Biosciences) column with 0.1 M Tris-HCl (pH 8.5), 0.02% Triton®-X 100, 0.25 M urea, 0.08% DTT and a linear NaCl gradient from 0 to 2 M over 50 ml for elution of the proteins (two runs in parallel).

All fractions were analyzed by MALDI-TOF. 20 μl of a fraction was concentrated and desalted using ZipTip_{μ-C18} (Millipore, Billerica, Mass., USA) according to the user manual. ZipTips were washed with 50% acetonitrile, 0.1% TFA and equilibrated with 0.1% TFA. 0.1% TFA was used as washing solution. Elution was performed with 1.5 μl matrix solution (20 mg/ml sinapinic acid in 50% acetonitrile, 0.3% TFA) directly onto the MALDI target. Measurements were performed on a Voyager-DE STR MALDI-TOF (Applied Biosystems) mass spectrometer. Spectra of the following mass ranges were measured: 580-5000 Da (reflector mode, 20 kV accelerating voltage, delay time 200 nsec, low mass gate 580 Da), 4000-25000 Da (linear mode, 25 kV accelerating voltage, delay time 600 nsec, low mass gate 4000 Da), 20000-100000 Da (linear mode, 25 kV accelerating voltage, delay time 850 nsec, low mass gate 5000 Da). Per spectra 10 single measurements of 100-150 shots were accumulated. External calibration was performed using a Peptide/Protein mix from Laserbio (Sophia-Antipolis Cedex, France).

Biomarker M3 eluted at about 0.4 M NaCl. The most intense fractions (according to MALDI measurement) were combined and precipitated (TCA-DOC precipitation), by adding 1/100 vol. of 2% DOC (deoxycholate) to one volume of protein solution, vortexed and incubated for 30 min at 4° C. Subsequently 1/10 vol. of TCA was added, the sample was vortexed and incubated on ice for at least 15 min. Afterwards centrifugation was performed at 15000 g for 10 min at 4° C. The pellet was dried by inverting the tube. Pellet was washed twice with one volume cold acetone (vortex and re-pellet sample 5 min at full speed between washes). The sample was dried in a speed vac and resuspended in a minimal volume of sample buffer (0.1 M Tris-HCl (pH 8.5), 0.25 M urea, 0.08% DTT, 0.25 M NaCl).

The pooled sample was chromatographed on a Superdex Peptide (Amersham Biosciences) column with 0.1M Tris-HCl pH8.5, 0.25M urea, 0.08% DTT, 0.25M NaCl. All fractions were analyzed by MALDI-TOF as described above. Biomarker M3 was detected at the appropriate molecular weight.

The fraction (1 ml) containing biomarker M3 was applied to a reversed phase column. RP-HPLC was performed on a Vision Workstation (Applied Biosystems) at 10° C. using a 100×2 mm C8 Column (Prontosil 300-5-C8 SH 5 μm, Bischoff, Leonberg, Germany). Eluent A was 0.1% TFA in 95% H₂O, 5% acetonitrile; buffer B was 0.085% TFA in 95% acetonitrile, 5% H₂O. The gradient applied was linear from 0% B to 20% B in 3 min; 20% B to 45% B in 30 min and 45% B to 100% B in 3 min. All fractions of reversed-phase chromatography were dried in a vacuum concentrator and redissolved in 5 μl 50% acetonitrile, 0.1% (TFA). 0.7 μl redissolved sample was mixed with 0.7 μl matrix (20 mg/ml sinapinic acid in 50% acetonitrile, 0.3% TFA) and 1 μl was applied onto the MALDI target. Measurements were performed on a Voyager-DE STR MALDI-TOF (Applied Biosystems) mass spectrometer as described above. Biomarker M3 eluted at about 40% B.

The remaining fraction containing biomarker M3 was diluted with 40 μl 0.1% TFA and then processed with ZipTip_{μ-C18} (Millipore). The elution was performed with 2.5 μl 50% acetonitrile, 0.1% formic acid (FA). The eluate was analyzed by nano-electrospray MS/MS using a Q-TOF Micro (Micromass, Manchester, UK). ESI-MS/MS measurement was performed for m/z [M+5H]⁵⁺=1127.11. The molecular mass determined with ESI-MS was [M]=5630.53 Da (+−0.01%) (monoisotopic mass). The spectra were interpreted manually. Detected sequence information was used for database search with the search engine MASCOT (Matrixscience, London, UK). The peptide was identified as fragment of Prothrombin (amino acids 315-363, calculated monoisotopic molecular mass [M]=5630.73 Da). The peptide corresponds to the already identified peptide at 5483 Da, but contains an additional Arginine at the C-terminus.

The remaining sample prepared for ESI measurement (in 50% acetonitrile, 0.1% FA) was used for Peptide Mass Fingerprint (PMF). It was diluted with 5 μl digest buffer (50 mM ammonium bicarbonate buffer (pH 7.8)). 0.04 μg trypsin (Sequencing Grade Modified Trypsin, Promega, Madison, Wis., USA) was added per digest. The digest was performed over night at 37° C. in an incubator.

Desalting and concentration of the peptides prior to MALDI-MS were performed using ZipTip_{μ-C18} (Millipore) according to the user manual. ZipTips were washed with 50% acetonitrile, 0.1% TFA and equilibrated with 0.1% TFA. 0.1% TFA was used as washing solution. Elution was performed with 2.5 μl 50% acetonitrile, 0.1% TFA. 0.7 μl of the eluate was mixed with matrix (5 mg/ml α-cyano-4-hydroxy cinnamic acid, Aldrich) in 50% acetonitrile, 0.3% TFA) and 1 μl was applied onto the MALDI target. Measurements were performed on a Voyager-DE STR MALDI-TOF (Applied Biosystems) mass spectrometer using an automatic modus with automated internal calibration (with the tryptic autolysis masses 842.5 and 2211.1). The mass range was set to 580-5000 Da (reflector mode, 20 kV accelerating voltage, delay time 200 nsec, low mass gate 580 Da),

Proteins were identified after PMF using the search program MS-Fit (Protein Prospector). Searches were performed in the Swissprot database, mass accuracy was set to 20 ppm and two missed cleavage site were allowed, cysteines were considered as unmodified. Three tryptic peptides of Prothrombin precursor (SwissProt P00734) in the sequence part of amino acids 315-363 were detected.

### Example 7

### Staging of Colorectal Cancer

Two of these models (one developed on FCCC samples, one developed on ETSI samples) were subsequently evaluated on the remainder of the samples available, giving one model trained on FCCC samples and tested on ETSI samples, the other trained on ETSI samples and tested on FCCC samples. Performance of these models is given in Table 12. Performance is given for the FCCC and ETSI sample sets, as well as the two sample sets pooled together. Performance is given in terms of test sensitivity and specificity, with sensitivity set to be 95%.

TABLE 13
Performance of logistic regression models for CRCa
diagnosis in comparison to individual CRCa markers.

| | | Sample Set | | |
|---|---|---|---|---|
| | | FCCC | ETSI | Pooled |
| Individual | M1 | 95.7/13.6 | 94.2/48.7 | 94.8/18.1 |
| Markers | M2 | 94.5/13.0 | 94.0/37.7 | 94.8/19.2 |
| | M3 | 94.2/13.9 | 94.2/33.2 | 94.8/19.5 |
| | M4 | 94.7/20.7 | 94.2/19.1 | 94.8/20.1 |
| | M5 | 94.7/18.3 | 94.2/27.6 | 94.8/21.3 |
| | M6 | 94.6/23.0 | 94.2/25.6 | 94.8/23.1 |

| | | | |
|---|---|---|---|
| FCCC Model | 94.7/22.5 | 94.9/53.2 | 94.8/26.0 |
| ETSI Model | 94.7/17.5 | 94.9/54.8 | 94.9/22.4 |

Values are given as % sensitivity/% specificity
FCCC Model: logistic regression model trained on FCCC sample data
ETSI Model: logistic regression model trained on ETSI sample data
Pooled: FCCC and ETSI samples together

TABLE 14
Application of biomarkers to colorectal
cancer staging in ETSI samples.

Comparison . . .

B

| Approximate | A | | ROC- |
|---|---|---|---|
| Biomarker M/Z | P | P | AUC |
| 3930 | 0.34 | 0.14 | 0.61 |
| 5060 | 0.12 | 0.024 | 0.67 |
| 5615 | 0.46 | 0.53 | 0.46 |
| 11430 | 0.011 | 0.021 | 0.68 |
| 11540 | 1.7 × 10⁻³ | 5.5 × 10⁻³ | 0.72 |
| 11680 | 7.2 × 10⁻³ | 7.4 × 10⁻³ | 0.71 |

A: Stage I vs Stage II vs Stage III vs Stage IV cancer
B: Stage I/II cancer vs Stage III/IV cancer

TABLE 15
Distribution of patient population across disease stage

| Disease | |
|---|---|
| Stage | # Patients |
| Pre-cancerous | 2 |
| Stage I | 8 |
| Stage II | 0 |
| Stage IIA | 10 |
| Stage IIB | 3 |
| Early Stage | 23 |
| Cancer | |
| Stage IIIA | 4 |
| Stage IIIB | 8 |
| Stage IIIC | 10 |
| Stage IV | 13 |
| Late StageCancer | 35 |

### REFERENCES

1. Huang C S, Lal S K, and Farraye F A. (2005). Colorectal cancer screening in average risk individuals. Cancer Causes and Control 16:171-188.
2. American Cancer Society, Cancer Facts and Figures 2005. Atlanta: American Cancer Society; 2005.
3. Janout V, and Kollarova H. (2001). Epidemiology of colorectal cancer. Biomed Pap Med Fac Univ Palacky Olomouc Czech Repub 145(1):5-10.
4. Sandler R. S. (1999). Prevention of Colorectal Cancer. Current Treatment Options in Gastroenterol. 2(1):27-33.
5. Wong W D. Current concepts in the management of colorectal cancer. Available at http://www.fcmsdocs.org/Conference/11th/Current%20Concepts%20in%20the%20Management%20of%20Colorectal%20Cancer.pdf Cited on Apr. 4, 2006.
6. Hendon S E, and DiPalma J A. (2005). U.S. practices for colon cancer screening. Keio J. Med. 54(4):179-183.
7. Galiatsatos P, and Foulkes W D. (2006). Familiar adenomatous polyposis. Am J. Gastroenterol. 101(2): 385-398.
8. Moayyedi P, and Achkar E. (2006). Does fecal occult blood testing really reduce mortality? A reanalysis of systemic review dada. Am J. Gastroenterol. 101(2):380-384.
9. Mandel J S, Bond J H, Church T R, Snover D C, Bradley G M, Schuman L M, and Ederer F. (1993). Reducing mortality from colorectal cancer by screening for fecal occult blood. Minnesota Colon Cancer Control Study. N Engl J Med. 328:1365-1371.
10. Atkin W S, Cuzick J, Northover J M, and Whynes D K. (1993). Prevention of colorectal cancer by one-only sigmoidoscopy. Lancet 341:736-740.
11. Lieberman D A, Weiss D G, Bond J H, Ahnen D J, Garewal H, and Chejfec G. (2000). Use of colonoscopy to screen asymptomatic adults for colorectal cancer. N Engl J Med. 343:162-168.
12. Laghi A. (2005). Virtual colonoscopy: clinical application. Eur Radiol. 15(Suppl 4):D138-141.
13. Bogoni L, Cathier P, Dundar M, Jerebko A, Lakare S, Liang J, Periaswamy S, Baker M E, Macari M. (2005). Computer-aided detection (CAD) for CT colonography: a tool to address a growing need. Br J Radiol. 78 Spec No 1:S57-62.
14. Prokop M. (2005). Cancer screening with CT: dose controversy. Eur Radiol. 15 Suppl 4:d55-61.
15. Bemis L T, Geske F J, and Strange, R. (1995). Use of the yeast two-hybrid system for identifying the cascade of protein interactions resulting in apoptotic cell death. Methods in Cell Biology 46:139-151.
16. Fields S, and Sternglanz R. (1994). The two-hybrid system: an assay for protein-protein interactions. Trends Genet. 10(8):286-292.
17. Topcu Z, and Borden K L. (2000). The yeast two-hybrid system and its pharmaceutical significance. Pharm Res. 17(9)1049-1055.
18. Zhang B, Kraemer B, SenGupta D, Fields S, and Wickens M. (1999). Yeast three-hybrid system to detect and analyze interactions between RNA and protein. Methods Enzymol. 306:93-113.
19. Palmer A, Gavin A C, and Nebreda A R. (1998). A link between MAP kinase and p34(cdc2)/cyclin B during oocyte maturation: p90(rsk) phosphorylates and inactivates the p34(cdc2) inhibitory kinase Myt1. Embo J. 17(17)4037-5047.
20. Scott J K, and Smith G P. (1990). Searching for peptide ligands with an epitope library. Science 249(4967):386-390.
21. Bindseil K U, Jakupovic J, Wolf D, Lavayre J, Leboul J, van der Pyl, D. (2001). Pure compound libraries; a new perspective for natural product based drug discovery. Drug Discov Today 6(16):840-847.
22. Grabley S, Thiericke R, and Sattler I. (2000). Tools for drug discovery: natural product-based libraries. Ernst Schering Res Found Workshop (32):217-252.
23. Houghten R A, Wilson D B, and Pinilla C. (2000). Drug discovery and vaccine development using mixture-based synthetic combinatorial libraries. Drug Discov Today 5(7):276-285.
24. Rader C. (2001). Antibody libraries in drug and target discovery. Drug Discov Today 6(1):36-43.
25. DeWitt S H, Kiely J S, Stankovic C J, Schroeder M C, Cody D M, and Pavia M R. (1993) “Diversomers”: an approach to nonpeptide, nonoligomeric chemical diversity. Proc Natl Acad Sci USA 90(15):6909-6913.
26. Erb E, Janda K D, and Brenner S. (1994). Recursive deconvolution of combinatorial chemical libraries. Proc Natl Acad Sci USA 91(24): 11422-11426.
27. Gallop M A, Barrett R W, Dower W J, Fodor S P, and Gordon E M. (1994). Applications of combinatorial technologies to drug discovery. 1. Background and peptide combinatorial libraries. J Med Chem. 37(9):1233-1251.
28. Gordon E M, Barrett R W, Dower W J, Fodor S P, and Gallop M A. (1994). Applications of combinatorial technologies to drug discovery. 2. Combinatorial organic synthesis, library screening strategies, and future directions. J Med Chem. 37(10):1385-1401.

29. Houghten R A, Appel J R, Blondelle S E, Cuervo J H, Dooley C T, and Pinilla C. (1992). The use of synthetic peptide combinatorial libraries for the identification of bioactive peptides. Biotechniques 13(3):412-421.
30. Lam K S, Salmon S E, Hersh E M, Hruby V J, Kazmierski W M, and Knapp R J. (1991). A new type of synthetic peptide library for identifying ligand-binding activity. Nature 354(6348):82-84.
31. Fodor S P, Rava R P, Huang X C, Pease A C, Holmes C P, and Adams C L. (1993). Multiplexed biochemical assays with biological chips. Nature 364(6437):555-556.
32. Cull M G, Miller J F, and Schatz P J. (1992) Screening for receptor ligands using large libraries of peptides linked to the C terminus of the lac repressor. Proc Natl Acad Sci USA 89(5):1865-1869.
33. Devlin J J, Panganiban L C, and Devlin P E. (1990). Random peptide libraries: a source of specific protein binding molecules. Science 249(4967):404-406.
34. Cwirla S E, Peters E A, Barrett R W, and Dower W J. (1990) Peptides on phage: a vast library of peptides for identifying ligands. Proc Natl Acad Sci USA 87(16):6378-6382.
35. Felici F, Castagnoli L, Musacchio A, Jappelli R, and Cesareni G. (1991) Selection of antibody ligands from a large library of oligopeptides expressed on a multivalent exposition vector. J Mol Biol. 222(2):301-310.
36. Waldman T A. (1991). Monoclonal antibodies in diagnosis and therapy. Science 252(5013):1657-1662.
37. Harlow E, and Lane D. (eds.). (1988). Antibodies: A Laboratory Manual, Cold Harbour Press, Cold Harbour, N.Y.
38. Goding J W. (1996). Monoclonal Antibodies: Principles and Practice: Production and Application of Monoclonal Antibodies in Cell Biology, Biochemistry and Immunology, 3^{rd} edition, Academic Press, NY.
39. Huse W D, Sastry L, Iverson S A, Kang A S, Alting-Mees M, Burton D R, Benkovic S J and Lerner R A. (1989). Generation of a large combinatorial library of the immunoglobulin repertoire in phage lambda. Science 246(4935):1275-1281.
40. Kohler G, and Milstein C. (1975). Continuous cultures of fused cells secreting antibody of predefined specificity. Nature 256(5517):495-497.
41. Kozbor et al. (1983). Immunology Today 4:72.
42. Cote R J, Morrissey D M, Houghton A N, Beattie E J Jr., Oettgen H F, and Old, L. J. (1983). Generation of human monoclonal antibodies reactive with cellular antigens. Proc Natl Acad Sci USA. 80(7):2026-2030.
43. Cole et al. (1985). Monoclonal Antibodies in Cancer Therapy. Alan R. Liss, Inc., pp. 77-96.
44. Morrison D A, Trombe M C, Hayden M K, Waszak G A, and Chen J D. (1984). Isolation of transformation-deficient Streptococcus pneumoniae mutants defective in control of competence, using insertion-duplication mutagenesis with the erythromycin resistance determinant of pAM beta 1. J Bacteriol. 159(3):870-876.
45. Neuberger M S, Williams G T, and Fox R O. (1984). Recombinant antibodies possessing novel effector functions. Nature 315(5995):604-608.
46. Takeda S, Naito T, Hama K, Noma T, and Honjo T. (1985). Construction of chimaeric processed immunoglobulin genes containing mouse variable and human constant region sequences. Nature 314(6010):452-454.

We claim:

1. A method for diagnosing colorectal cancer in a subject comprising:
(a) obtaining a biological sample from the subject;
(b) detecting a quantity, presence, or absence of one or more of biomarkers M1, M2, M3, M4, M5, or M6 in said sample;
(c) classifying said subject as having or not having colorectal cancer, based on said quantity, presence, or absence of said biomarkers.

2. The method according to claim 1, wherein the step of classifying said subject comprises comparing the quantity, presence or absence of at least one of said biomarkers with a reference biomarker panel indicative of a colorectal cancer.

3. A method for differential diagnosis of colorectal cancer and non-malignant disease of the large intestine in a subject, comprising:
(a) obtaining a biological sample from the subject;
(b) detecting a quantity, presence, or absence of one or more of biomarkers M1, M2, M3, M4, M5, and M6 in said sample;
(c) classifying said subject as having colorectal cancer, as having non-malignant disease of the large intestine, or as healthy, based on the quantity, presence, or absence of one or more said biomarkers in said biological sample.

4. The method according to claim 3, wherein classifying said subject comprises comparing the quantity, presence, or absence of at least one of said biomarkers with a reference biomarker panel indicative of colorectal cancer and a reference biomarker panel indicative of a non-malignant disease of the large intestine.

5. The method according to claim 1, wherein one or more said biomarkers are used to classify said subject by:
(a) contacting the biological sample with a biologically active surface,
(b) allowing the biomarkers within the biological sample to bind to the biologically active surface;
(c) detecting a bound biomarker using a detection method, wherein the detection method generates mass profiles of said biological sample;
(d) transforming information obtained in (c) into a computer readable form; and
(e) comparing the information in (d) with a database containing mass profiles from subjects whose classification is known;
wherein said comparison allows for the differential diagnosis and classification of a subject.

6. The method according to claim 5, wherein the database is generated by
(a) obtaining reference biological samples from subjects having a known classification;
(b) contacting the reference biological samples in (a) with a biologically active surface,
(c) allowing biomarkers within the reference biological samples to bind to the biologically active surface,
(d) detecting bound biomarkers using a detection method, wherein the detection method generates mass profiles of said reference biological samples,
(e) transforming the mass profiles into a computer-readable form, and
(f) applying a mathematical algorithm to classify the mass profiles in (d) into desired classification groups.

7. The method according to claim 1, wherein the quantity, presence, or absence of one or more of the biomarkers is detected in the biological sample obtained from the subject by mass spectrometry.

8. The method according to claim 7, wherein the method of mass spectrometry is selected from the group consisting of matrix-assisted laser desorption ionization/time of flight (MALDI-TOF), surface enhanced laser desorption ionisation/time of flight (SELDI-TOF), liquid chromatography, MS-MS, or ESI-MS.

9. The method according to claim 1, wherein the quantity, presence, or absence of the biomarker is detected or quantified in the biological sample obtained from the subject utilizing an antibody to said biomarker.

10. The method according to claim 1, wherein the quantity, presence, or absence of the biomarker is detected or quantified in the biological sample obtained from the subject by an ELISA assay.

11. The method according to claim 1, wherein the subject is a mammal.

12. The method according to claim 11, wherein the mammal is a human.

13. The method according to claim 1, wherein the biological sample is selected from the group consisting of: blood, serum, plasma, urine, semen, seminal fluid, seminal plasma, prostatic fluid, pre-ejaculatory fluid (Cowper's fluid), excreta, tears, saliva, sweat, biopsy, ascites, cerebrospinal fluid, lymph, and tissue extract sample or biopsy

14. The method according to claim 5, wherein the biologically active surface comprises an adsorbent consisting of cationic, quaternary ammonium groups.

15. A database containing a plurality of database entries useful in diagnosing subjects as having or not having colorectal cancer, comprising:
(a) a categorization of each database entry as either characteristic of having or not having colorectal cancer;
(b) a characterisation of each database entry as either having, not having, or having in a certain quantity, a biomarker selected from the group consisting of biomarker M1, M2, M3, M4, M5, and M6.

16. A database generated by:
(a) obtaining reference biological samples from subjects known to have, and patients known not to have, colorectal cancer;
(b) contacting the reference biological samples in (a) with a biologically active surface;
(c) allowing biomarkers within the reference biological samples to bind to the biologically active surface;
(d) detecting bound biomarkers using a detection method wherein the detection method generates mass profiles of said reference biological samples;
(e) transforming the mass profiles into a computer readable form; and
(f) applying a mathematical algorithm to classify the mass profiles in (d) as specific for healthy subjects or subjects having colorectal cancer.

17. The method according to claim 1, wherein the biomarkers are M1 and M4.

18. The method according to claim 1, wherein the biomarkers are M1 and M5.

19. The method according to claim 1, wherein the biomarkers are M1 and M6.

20. The method according to claim 1, wherein the biomarkers are M3 and M4.

21. The method according to claim 1, wherein the biomarkers are M3 and M5.

22. The method according to claim 1, wherein the biomarkers are M3 and M6.

23. The method according to claim 1, wherein the biomarkers are M2 and M4.

24. The method according to claim 1, wherein the biomarkers are M2 and M5.

25. The method according to claim 1, wherein the biomarkers are M2 and M6.

26. The method according to claim 1, wherein the biomarkers are M1, M2, M3, M4, M5 and M6.

27. A method for determining the stage of colorectal cancer in a subject comprising:
(a) obtaining a biological sample from the subject
(b) detecting the quantity of one or more of biomarkers M1, M2, M3, M4, M5 or M6 in said sample
(c) classifying said subject as having stage 0 or stage I or stage IIA or stage IIB or stage IIIA or stage IIIB or stage IIIC or stage IV colorectal cancer

28. A method according to claim 27, wherein the step of determining the stage of colorectal cancer in a subject comprises comparing the quantity of at least one of said biomarkers with a referenced panel indicative of stage 0 or stage I or stage IIA or stage IIB or stage IIIA or stage IIIB or stage IIIC or stage IV colorectal cancer.
